(19) United States
(12) Patent Application Publication
(10) Pub. No.: US 2026/0298963 A1
(43) Pub. Date: Oct. 1, 2026

(54) DEVICE FOR THE COLLECTION AND THE HANDLING OF SAMPLES AND ASSOCIATED METHOD

(71) Applicant: COPAN ITALIA S.P.A., BRESCIA (IT)

(72) Inventors: Arnalda GIAMBRA, BRESCIA (IT); Mario SAVARESE, BRESCIA (IT); Salvatore BALZANO, BRESCIA (IT); Andrea BONATTI, BRESCIA (IT)

(21) Appl. No.: 19/474,823

(22) PCT Filed: Apr. 10, 2024
(86) PCT No.: PCT/IB2024/053505

§ 371 Date: Oct. 13, 2025

(30) Foreign Application Priority Data
Apr. 14, 2023 (IT) 102023000007266

(51) Int. Cl. G01N 35/10; G01N 35/00

(52) U.S. Cl. CPC G01N 35/1011; G01N 35/1016; G01N 2035/00495

(57) ABSTRACT

The present disclosure concerns a device (1) for the collection and the handling of samples, preferably biological, microbiological or chemical samples, from a primary container (100), the device (1) comprising:—at least one support (2) configured for retaining at least one primary container (100) in a predefined position;—at least a sample collection unit (3), movable between at least:—a collecting position (3a) wherein said sample collection unit (3) collects at least part of the sample contained in said primary container (100), and retains a volume (V) of said sample; and -a first releasing position (3b) wherein said sample collection unit (3) releases at least part of the volume (V) of said sample in at least one secondary container or support (102, 103, 104); wherein the device (1) comprises a data processing unit (4) configured at least for determining the execution, in a substantially automated way, of:—a control in movement of the sample collection unit (3) between said collecting position (3a) and said at least one first releasing position (3b), and—an activation of the sample collection unit (3) for carrying out:—a collection of the volume (V) of the sample contained in said primary container (100), and—a release of the at least part of said volume (V) in said at least one secondary container or support (102, 103, 104); the device (1) further comprising a handling unit (5), configured at least for opening and/or closing a stopper (100t) of said primary container (100) configured for being removably coupled to a body (100b) of said primary container (100); and wherein the handling unit (5) is configured and specifically destined to open and/or close primary containers (100) having stoppers and/or bodies (100b) of different size and/or shape.

### FIELD OF THE INVENTION

The present disclosure pertains to the field of devices for the handling of containers for samples, preferably for samples of biological or microbiological or chemical type.

In detail the present disclosure concerns a device for the collection and the handling of samples, preferably biological, microbiological or chemical samples.

The present disclosure also concerns a method for the collection and the handling of samples, preferably biological, microbiological or chemical samples.

The present disclosure also concerns a computer program that when executed is destined to cause the execution of said method.

The present disclosure also concerns a use of said device.

### KNOWN ART

The current technology of analysis of biological and/or microbiological and/or chemical samples allows a very accurate analysis in the potential detection of particular substances and/or components in the above-mentioned samples. For example, analyses aimed at detecting the presence of particular viruses, bacteria, fungi, molds, protozoa, proteins, blood or plasma or particular cell types can be carried out with great reliability.

It is also known that—especially in the field of preventive medicine—mass screenings, thus involving a large number of samples, can be of particular relevance not only for research purposes but also on the direct health of individuals.

The need has emerged of having machines capable of quickly processing a large quantity of samples. Among the machines of known type are known machines that transfer samples from a primary container to a secondary support. The primary container is the container wherein it is typically collected the sample. The secondary support is the one on which a part of sample is transferred for the execution of one or more analyses.

The current market for the above-mentioned machines is of limited spread, and therefore the machines are often destined to the preparation of a single mono-brand assay. The operational flexibility of the above-mentioned machines is therefore limited.

In order to overcome the above-described drawbacks, the purpose of the present disclosure is to provide a device for the collection and the handling of samples, a relative method, a computer program and the use of said device that allow to overcome the above-described drawbacks.

### SUMMARY

The object of the present disclosure is now described in some of its salient aspects, which can be combined with each other and with portions of the detailed description and/or claims.

According to the present disclosure is described a device (1) for the collection and the handling of samples, preferably biological, microbiological or chemical samples, from a primary container (100), the device (1) comprising:
at least one support (2) configured for retaining at least one between a primary container (100) and/or a secondary container or support (102, 103, 104) in a predefined position,
at least a sample collection unit (3), movable between at least:
   a collecting position (3a) wherein said sample collection unit (3) collects at least part of the sample contained in said primary container (100), and retains a volume (V) of said sample; and
   a first releasing position (3b) wherein said sample collection unit (3) releases at least part of the volume (V) of said sample in at least one secondary container or support (102, 103, 104);
wherein the device (1) comprises a data processing unit (4) configured at least for determining the execution, in a substantially automated way, of:
   a control in movement of the sample collection unit (3) between said collecting position (3a) and said at least one first releasing position (3b), and
   an activation of the sample collection unit (3) for carrying out:
      a collection of the volume (V) of the sample contained in said primary container (100), and
      a release of the at least part of said volume (V) in said at least one secondary container or support (102, 103, 104).

According to the present disclosure is described a device (1) for the collection and the handling of samples, preferably biological, microbiological or chemical samples, from a primary container (100), the device (1) comprising:
at least one support (2) configured for retaining at least one between a primary container (100) and/or a secondary container or support (102, 103, 104) in a predefined position,
at least a sample collection unit (3), movable between at least:
a collecting position (3a) wherein said sample collection unit (3) collects at least part of the sample contained in said primary container (100), and retains a volume (V) of said sample; and
a first releasing position (3b) wherein said sample collection unit (3) releases at least part of the volume (V) of said sample in at least one secondary container or support (102, 103, 104);

wherein the device (1) comprises a data processing unit (4) configured at least for determining the execution, in a substantially automated way, of:
a control in movement of the sample collection unit (3) between said collecting position (3a) and said at least one first releasing position (3b), and
an activation of the sample collection unit (3) for carrying out:
a collection of the volume (V) of the sample contained in said primary container (100), and
a release of the at least part of said volume (V) in said at least one secondary container or support (102, 103, 104);

the device (1) further comprising a handling unit (5), configured at least for opening and/or closing a stopper (100t) of said primary container (100) configured for being removably coupled to a body (100b) of said primary container (100);

and wherein the handling unit (5) is configured and specifically destined to open and/or close primary containers (100) having stoppers and/or bodies (100b) of different size and/or shape.

According to another non-limiting aspect, the assembly formed by the support (2) and by the handling unit (5) is configured and specifically destined to adapt in a substantially automated way at least at the opening and/or closing of:
at least one first stopper (100t) of a first primary container (100), and
at least one second stopper (100t) of a second primary container (100).

According to another non-limiting aspect, the first and the second primary container (100) differ in correspondence of said first and respectively second stopper (100t), for type and/or shape and/or size or the first and the second primary container (100) differ in correspondence of said body (100b) for type and/or shape and/or size.

According to another non-limiting aspect, the handling unit (5) is configured and specifically destined to adapt in a substantially automated way at least to the opening and/or closing of:
at least one first stopper (100t) of a first primary container (100), and
at least one second stopper (100t) of a second primary container (100).

According to another non-limiting aspect, the handling unit (5) is configured for directly contacting the stopper (100t) of said primary container (100) and/or said first stopper (100t) of said first primary container (100) and said second stopper of said second primary container (100).

According to another non-limiting aspect, said data processing unit (4) is configured for determining the activation, in a substantially automated way, of said handling unit (5), for at least the unscrewing of said stopper (100t), before the activation and/or the control in movement of the sample collection unit (3) or in substantial temporal simultaneity with the activation and/or the control in movement of the sample collection unit (3).

According to another non-limiting aspect, said handling unit (5) is configured at least for opening said stopper (100t) when said primary container (100) is in said collecting position (3a).

According to another non-limiting aspect, said handling unit (5) is configured for separating said stopper (100t) from said body (100b) when in said collecting position (3a) and/or said handling unit (5) is configured for opening said stopper (100t) by means of at least one between a movement of rotation and translation and preferably by means of a combined and simultaneous movement of rototranslation.

According to another non-limiting aspect, the handling unit (5) comprises at least one gripper (5p) configured for contacting a surface, preferably outer, of said stopper (100t) and for retaining said surface, at least during the opening and the separation of the stopper (100t) from the body (100b) preventing a relative rotation of said stopper (100t) with respect to said gripper (5p) and/or preventing a relative translation between said stopper (100t) and said gripper (5p).

According to another non-limiting aspect, said gripper is radially movable between at least:
a distanced position with respect to said stopper (100t),
a contact position with said stopper (100t).

According to another non-limiting aspect, the handling unit (5) is configured for moving said gripper (5p) between said distanced position and said contact position when said gripper (5p) is radially aligned to said stopper (100t).

According to another non-limiting aspect, said sample collection unit (3) and/or said handling unit (5) are arranged at a height higher with respect to a height at which lies said support (2).

According to another non-limiting aspect, the distanced position with respect to said stopper (100t) and the contact position with said stopper (100t) are both at a same height with respect to said support (2).

According to another non-limiting aspect, the sample collection unit (3) is configured for releasing at least part of the volume (V) of said sample collected in secondary containers or supports (102, 103, 104) of heterogeneous type, and/or the sample collection unit (3) is movable between said collecting position (3a) and/or said first releasing position (3b) and a second releasing position (3b′).

According to another non-limiting aspect:
in said first releasing position (3b) said sample collection unit (3) releases at least a first part of the volume (V) of said sample collected in a first secondary container or support (102);
in said second releasing position (3b′) said sample collection unit (3) releases at least second part of the volume (V) of said sample collected in at least one second secondary container or support (103, 104).

According to another non-limiting aspect, the data processing unit (4) is configured for determining, in a substantially automated way, a control in movement of the sample collection unit (3) from the collecting position (3a) to the first releasing position (3b) and, subsequently, from the first releasing position (3b) to the second releasing position (3b′).

According to another non-limiting aspect, said sample collection unit (3) comprises, or is, a pipetting unit.

According to another non-limiting aspect, said sample collection unit (3) comprises a sample collection element in form of a hollow tip, configured for retaining at least said volume (V) of said sample.

According to another non-limiting aspect, said hollow tip is configured for being removably connected to a support for tips of said sample collection unit (3).

According to another non-limiting aspect, the sample collection unit (3) comprises a pump, operatively connected to said hollow tip and configured for sucking or pushing at least part of said volume (V) of said sample respectively inside or outside of said hollow tip.

According to another non-limiting aspect, the sample collection unit (3) is configured for determining said volume (V) of said sample collected from said primary container (100) or at least partially released in said at least one secondary container or support (102, 103, 104) and/or sucked or pushed respectively inside or outside of said hollow tip in function of a movement of an actuator of said pump.

According to another non-limiting aspect, at least one between the sample collection unit (3) and/or said hollow tip presents a volume sensor configured for detecting a volume of sample present within said hollow tip.

According to another non-limiting aspect, said volume sensor is configured for transmitting a control signal having a value function of said volume of sample present within said hollow tip.

According to another non-limiting aspect, the sample collection unit (3) is configured for determining said volume (V) of said sample collected from said primary container (100) or at least partially released in said at least one secondary container or support (102, 103, 104) and/or sucked or pushed respectively inside or outside of said hollow tip in function of the control signal provided by said volume sensor.

According to another non-limiting aspect, the sample collection unit (3) is a pipetting unit.

According to another non-limiting aspect, said pipetting unit comprises at least one pump for the sucking and/or the controlled release of said volume (V) of said sample.

According to another non-limiting aspect, said sample collection unit (3) comprises at least one support for a sample collection element (3p).

According to another non-limiting aspect, said sample collection element (3p) comprises a collection loop and/or a spoon and/or a cylinder and/or a ring and/or a hollow tip.

According to another non-limiting aspect, said sample collection element (3p) is of disposable type.

According to another non-limiting aspect, said sample collection element (3p) is removably connected to the sample collection unit (3) on said support.

According to another non-limiting aspect, said hollow tip is operatively connected to said at least one pump for allowing the collection and the retaining of said volume (V) of said sample.

According to another non-limiting aspect, said device (1) comprises a disposal unit for said sample collection element (3p).

According to another non-limiting aspect, said disposal unit comprises a duct or discharging hopper (3k) and a disposal container connected to said duct or discharging hopper (3k).

According to another non-limiting aspect, said disposal container (3c) is placed under said duct or discharging hopper (3k).

According to another non-limiting aspect, at least two between said collecting position (3a), said first releasing position (3b) and said second releasing position (3b′) are arranged at a same height.

According to another non-limiting aspect, the data processing unit (4) is configured for determining, in a substantially automated way, a control in movement of the sample collection unit (3) from the collecting position (3a) to the first releasing position (3b) by means of a composite movement comprising:
a raising of the height from a first lower height to a second higher height,
a translation along a plane, when at a height different with respect to said first lower height, in particular when at said second higher height.

According to another non-limiting aspect, the device (1) comprises at least one between a centrifugation unit (6) and an agitation unit (7) for said at least one primary container (100) and/or said secondary container or support (102, 103, 104).

According to another non-limiting aspect, said centrifugation unit (6) is configured for centrifugating said primary container (100) pushing by centrifugal force a part of the sample within a predefined portion, optionally a bottom portion, of said at least one primary container (100) and/or of said secondary container or support (102, 103, 104).

According to another non-limiting aspect, said agitation unit (7) is configured for agitating said sample contained in said primary container (100) and/or said secondary container or support (102, 103, 104) preferably moving said primary container (100) and/or said secondary container or support (102, 103, 104) on a movement of rotation eccentric with respect to a reference axis (K).

According to another non-limiting aspect said reference axis (K) is substantially vertical.

According to another non-limiting aspect, said data processing unit (4) is configured for activating said centrifugation unit (6) and/or said agitation unit (7) in a predefined temporal sequence with respect to the activation of said sample collection unit (3), and optionally for activating said centrifugation unit (6) and/or said agitation unit (7) before the activation of said sample collection unit (3).

According to another non-limiting aspect, at least one between said agitation unit (7) and said centrifugation unit (6) is positioned in substantial correspondence of said support (2), preferably said centrifugation unit (6) is positioned in substantial correspondence of said support (2).

According to another non-limiting aspect, the centrifugation unit (6) is positioned remotely with respect to said support (2) or lies on a same support plane (2) on which lies or is installed the support (2).

According to another non-limiting aspect, the centrifugation unit (6) comprises a secondary support (6s) configured for housing and retaining said primary container (100) and/or said secondary container or support (102, 103, 104) during its centrifugation.

According to another non-limiting aspect, said handling unit (5) is configured for moving said at least one primary container (100) between said support (2) and said centrifugation unit (6), in particular said secondary support (6s) by means of a predefined movement, preferably composite of rotation, of translation or of rototranslation.

According to another non-limiting aspect, said handling unit (5) is configured for moving said at least one primary container (100) between said support (2) and said centrifugation unit (6) retaining said at least one primary container (100) in correspondence of a predefined retaining portion, preferably in correspondence of said stopper (100t) According to another non-limiting aspect, said data processing unit (4) is configured for activating said handling unit (5) for moving said at least one primary container (100) between said support (2) and said centrifugation unit (6) in a predefined temporal sequence with respect to the activation of said sample collection unit (3), and optionally for activating said handling unit (5) for moving said at least one primary container (100) before the activation of said sample collection unit (3).

According to another non-limiting aspect, the gripper (5p) is configured for contacting said surface, preferably outer, of said stopper (100t) and for retaining said surface, at least during the movement of said primary container (100) between said support (2) and said centrifugation unit (6).

According to another non-limiting aspect, the device (1) comprises at least one filling unit (8, 8′), comprising at least one feeding duct (8c, 8c′) of at least a substance, preferably fluid, preferably within said at least one between said at least one primary container (100) and said secondary container or support (102, 103, 104).

According to another non-limiting aspect, said at least one filling unit (8, 8′) is configured for carrying out a rehydration and/or dilution and/or a lysis and/or a reaction of the sample contained in said at least one between said at least one primary container (100) and said secondary container or support (102, 103, 104).

According to another non-limiting aspect, said at least one filling unit (8, 8′) is configured for adding a controlled volume of said at least a substance in said at least one primary container (100) when said primary container (100) is in correspondence of said support (2) and/or in said at least one secondary container or support (102, 103, 104) when said secondary container or support (102, 103, 104) is in correspondence of said support (2). According to another non-limiting aspect, said at least one filling unit (8, 8′) comprises a pump (8p), optionally an occlusive pump, operatively connected to said duct (8c, 8c′).

According to another non-limiting aspect, said at least one duct (8c, 8c′) is of flexible and/or compressible type.

According to another non-limiting aspect, said occlusive pump acts in use on said duct (8c, 8c′) compressing it, determining said feeding of said controlled volume of said at least a substance within said at least one between said at least one primary container (100) and said secondary container or support (102, 103, 104).

According to another non-limiting aspect, said filling unit comprises at least one tank (8k, 8k′) connected, preferably removably, to said duct (8c, 8c′).

According to another non-limiting aspect, said tank (8k, 8k′) is substantially floppy and/or compressible, preferably configured for deforming after a progressive emptying from said substance.

According to another non-limiting aspect, said at least one filling unit (8, 8′) is configured and specifically destined to add said at least a substance, simultaneously, in a plurality of primary containers (100) or in a plurality of secondary containers or supports (102, 103, 104) or in at least one first primary container (100) and in at least one first secondary container or support (102, 103, 104).

According to another non-limiting aspect, said at least one filling unit (8, 8′) comprises a movable actuator (8m, 8m′), connected to a predefined portion, preferably an ending portion, of said duct (8c, 8c′).

According to another non-limiting aspect, said movable actuator (8m, 8m′) is configured for being moved at least between:
a first operating position wherein said predefined portion, preferably said ending portion, of said duct (8c, 8c′) is substantially aligned to an opening of said at least one primary container (100) and/or of said at least one secondary container or support (102, 103, 104),
a second operating position wherein said predefined portion, preferably an ending portion, of said duct (8c, 8c′) is misaligned with respect to said opening of said at least one primary container (100) and/or of said secondary container and/or support (102, 103, 104).

According to another non-limiting aspect, the movement between said first operating position and said second operating position occurs by means of a rotation of said movable actuator (8m, 8m′) around a predefined axis, preferably substantially vertical.

According to another non-limiting aspect, said data processing unit (4) is configured for:
keeping deactivated said pump (8p) when said movable actuator (8m, 8m′) is in said second operating position;
activating said pump (8p) when said movable actuator (8m, 8m′) is in said first operating position;

and optionally
keeping activated said pump (8p) for a time sufficient to supply a predefined volume of the at least a substance;
deactivating the pump (8p) before the movement of the movable actuator (8m, 8m′) from the first operating position to the second operating position.

According to another non-limiting aspect, the device (1) comprises at least one first loading station (9, 39) configured for housing a plurality of primary containers (100) and said handling unit (5) is configured for moving at least one primary container (100) from said at least one first loading station (9, 39) to said support (2) by means of a predefined movement, preferably composite of rotation, of translation or of rototranslation.

According to another non-limiting aspect, said at least one first loading station (9, 39) comprises at least one slide (9s) configured for housing removably at least one magazine (9c) having a plurality of seats for said primary containers (100).

According to another non-limiting aspect, said seats are suitable for housing, each one, a respective primary container (100).

According to another non-limiting aspect, said at least one first loading station (9, 39) comprises a plurality of slides (9s) configured for housing removably a respective plurality of said magazines (9c).

According to another non-limiting aspect, said plurality of slides (9s) allows the independent introduction and/or extraction of a respective magazine (9c).

According to another non-limiting aspect, said plurality of slides (9s) comprises at least a first and a second slide, said first and said second slide being arranged along a respective first and second direction substantially parallel and/or being arranged on a same plane.

According to another non-limiting aspect, said at least one first loading station (9, 39) is configured for allowing the electronic identification of said at least one magazine (9c), preferably for allowing the selective electronic identification of each magazine of said plurality of magazines (9c).

According to another non-limiting aspect, each magazine of said plurality of magazines (9c) comprises an electronic identification tag (9z), and said at least one first loading station (9, 39) comprises a reader (9r) for said electronic identification tag, and the electronic identification of said at least one magazine (9c) comprises a reading of electronic data stored in said electronic identification tag (9z).

According to another non-limiting aspect, said at least one first loading station (39) comprises:
a conveyor (39c) configured for moving a primary container (100) from a first starting position to a second arrival position (39e),
at least one magazine (39c) configured for housing a plurality of primary containers (100).

According to another non-limiting aspect, said at least one magazine (39c) comprises, and/or is joined to, at least one singularizer or separator (39b) configured for transferring a primary container (100) of said plurality of primary containers (100) from said magazine (39c) to said first starting position.

According to another non-limiting aspect, said data processing unit (4) is configured for activating the handling unit (5) for moving at least one primary container (100) from said second arrival position to said support (2) by means of a predefined movement, preferably composite of rotation, of translation or of rototranslation, and for opening and/or closing the stopper (100t) of said primary container (100) when the primary container (100) is in correspondence of said support (2),
or said data processing unit (4) is configured for activating the handling unit (5) for opening and/or closing the stopper (100t) of said primary container (100) when the primary container (100) is in said second arrival position (39e), or for activating the handling unit (5) for transferring the primary container (100) from said second arrival position (39e) or from said support (2) to a storage area (39g) of said at least one first loading station (39).

According to another non-limiting aspect, said device comprises a first loading station (9) and a second loading station (39), each one configured for housing a plurality of primary containers (100), preferably wherein said first loading station (9) is configured for housing a plurality of primary containers (100) of a first type and/or size and/or shape and said second loading station (39) is configured for housing a plurality of primary containers (100) of a second type and/or size and/or shape.

According to another non-limiting aspect, said handling unit (5) is configured for moving at least one primary container (100) from said first loading station (9) to said support (2) by means of a predefined movement, preferably composite, of rotation, of translation or of rototranslation, and for moving at least one primary container (100) from said second loading station (39) to said support (2), or from a first position to a second position within said second loading station (39) and/or for opening and/or closing at least one primary container (100) when positioned in said second loading station (39).

According to another non-limiting aspect, said first loading station (9) comprises at least one magazine (9c) having a plurality of seats configured for retaining, when housed, a plurality of primary containers (100) in a predefined spatial configuration.

According to another non-limiting aspect, said second loading station (39) comprises at least one magazine (39c) configured for housing a plurality of primary containers (100).

According to another non-limiting aspect, said at least one magazine (39c) is configured for allowing a relative movement between primary containers of said plurality of primary containers (100) when housed herein.

According to another non-limiting aspect, the device (1) comprises at least one releasing station (11) configured for housing a plurality of secondary containers (102, 103, 104).

According to another non-limiting aspect, said at least one releasing station (11) is configured for housing secondary containers (102, 103, 104) of different shape and/or size.

According to another non-limiting aspect, said first releasing position (3b) is arranged, optionally said first releasing position and said second releasing position (3b′) are arranged, in correspondence of said at least one releasing station (11).

According to another non-limiting aspect, said device (1) comprises an auxiliary support (13) for at least one secondary container (104), said auxiliary support (13) being arranged in a position different with respect to said releasing station (11).

According to another non-limiting aspect, said first releasing position (3b) is arranged in correspondence of said auxiliary support (13).

According to another non-limiting aspect, said handling unit (5) is configured for moving at least one secondary container or support (102, 103, 104) from said auxiliary support (13) to said releasing station (11) and/or for moving said primary container (100) from said support (2) to said releasing station (11) by means of a predefined movement, preferably composite of rotation, of translation or of rototranslation.

According to another non-limiting aspect, said device (1) comprises a conveying unit (12) independently movable with respect to said handling unit (5) and configured for moving at least one secondary container or support (102, 103, 104) from said auxiliary support (13) to said releasing station (11) and/or for moving said at least one primary container (100) from said support (2) to said releasing station (11).

According to another non-limiting aspect, the data processing unit (4) is configured for activating in a simultaneous or alternative way said handling unit (5) and said conveying unit (12), and preferably for activating in a simultaneous way the handling unit (5) and the conveying unit (12) respectively for moving at least one primary container (100) from said support (2) to said releasing station (11) and for moving said at least one secondary container or support (102, 103, 104) from said auxiliary support (13) to said releasing station (11).

According to another non-limiting aspect, said releasing station (11) comprises at least one slide (11s) configured for housing removably at least one magazine (11c) having a plurality of seats for said secondary containers (102, 103, 104).

According to another non-limiting aspect, said seats are configured for housing, each one, a respective secondary container or support (102, 103, 104).

According to another non-limiting aspect, said releasing station (11) comprises a plurality of slides (11s) configured for housing removably a respective plurality of said magazines (11c).

According to another non-limiting aspect, said plurality of slides (11s) allows the independent introduction and/or extraction of a respective magazine (11c).

According to another non-limiting aspect, the data processing unit (4) is configured for automatically activating said handling unit (5) and/or said conveying unit (12) for moving at least one secondary container or support (102, 103, 104) from said auxiliary support (13) to said releasing station (11) and/or for moving said primary container (100) from said support (2) to said releasing station (11) after said control in movement of the sample collection unit (3) from the collecting position (3a) to the first releasing position (3b) and, optionally, from the first releasing position (3b) to the second releasing position (3b′).

According to another non-limiting aspect, said at least one magazine (9c) comprises at least one first seat for a first primary container (100) and a second seat for a second primary container (100).

According to another non-limiting aspect, the data processing unit (4) is configured for determining the activation, in a substantially automated way, of said handling unit (5), for:
moving the handling unit (5) in correspondence of the first seat of the magazine (9c),
extracting from the first seat of the magazine (9c) at least one first primary container (100);
conveying said at least one first primary container (100) from the first seat of the magazine (9c) towards a position different with respect to a position of said first seat, preferably towards said support (2);
drawing said at least one first primary container (100) from the support (2);
moving the handling unit (5) in correspondence of the first seat of the magazine (9c);
depositing said at least one first primary container (100) in said first seat of the magazine (9c), and subsequently,
moving the handling unit (5) from the first seat to the second seat of the magazine (9c),
preferably, actuating said control in movement of the sample collection unit (3) after said transport of said at least one first primary container (100) from the first seat of the magazine (9c) towards said position different with respect to a position of said first seat.

According to another non-limiting aspect, the device (1) comprises a fracturation unit, configured for fracturing a predetermined portion (U) of an elongated body (100d) of a swab (100c) joined to the stopper (100t) of said primary container (100).

According to another non-limiting aspect, said fracturation unit is configured for causing a permanence of a collecting portion (100e) joined to said elongated body (100d) within said primary container (100) after the fracture. According to another non-limiting aspect, said fracturation unit is configured for moving said stopper (100t) with respect to a body (100b) of said primary container (100) for causing said fracturation.

According to another non-limiting aspect, said fracturation unit is configured for translating said stopper (100t) with respect to said body (100b) and determining said fracturation by means of an interference between the elongated body (100d) of said swab (100c) and said body (100b) of the primary container (100), preferably in substantial correspondence of said predetermined portion (U).

According to another non-limiting aspect, said handling unit (5) acts in quality of said fracturation unit.

According to another non-limiting aspect, the data processing unit (4) is configured for determining the activation of the sample collection unit (3) after said fracturation.

According to the present disclosure is further described a device (1) for the collection of samples, preferably biological, microbiological or chemical samples, from a primary container (100), the device (1) comprising:
at least one support (2) configured for retaining at least one between a primary container (100) and/or a secondary container or support (102, 103, 104) in a predefined position;
at least a sample collection unit (3), movable between at least:
   a collecting position (3a) wherein said sample collection unit (3) collects at least part of the sample contained in said primary container (100), and retains a volume (V) of said sample; and
   a first releasing position (3b) wherein said sample collection unit (3) releases at least part of the volume (V) of said sample in at least one secondary container or support (102, 103, 104);
wherein the device (1) comprises a data processing unit (4) configured at least for determining the execution, in a substantially automated way, of:
   a control in movement of the sample collection unit (3) between said collecting position (3a) and said at least one first releasing position (3b), and
   an activation of the sample collection unit (3) for carrying out:
   a collection of the volume (V) of the sample contained in said primary container (100), and
   a release of the at least part of said volume (V) in said at least one secondary container or support (102, 103, 104);
the device (1) comprising at least one filling unit (8, 8′), comprising at least one feeding duct (8c, 8c′) of at least a substance, preferably fluid, preferably within said at least one between said at least one primary container (100) and said secondary container or support (102, 103, 104);
wherein said at least one filling unit (8, 8′) comprises at least one tank (8k) removably connected to said duct (8c, 8c′), and/or wherein said at least one filling unit (8, 8′) is configured and specifically destined to add said at least a substance, preferably simultaneously, in a plurality of primary containers (100) or in a plurality of secondary containers or supports (102, 103, 104) or in at least one first primary container (100) and in at least one first secondary container or support (102, 103, 104).

According to another non-limiting aspect, said tank (8k) is substantially floppy and/or compressible, preferably configured for deforming after a progressive emptying from said substance.

According to another non-limiting aspect, said tank (8k) is substantially rigid, and is preferably realized in plastic or vitreous material.

According to the present disclosure is further described a device (1) for the collection and the handling of samples, preferably biological, microbiological or chemical samples, from a primary container (100), the device (1) comprising:
at least one support (2) configured for retaining at least one between a primary container (100) and/or a secondary container or support (102, 103, 104) in a predefined position
at least a sample collection unit (3), movable between at least:
   a collecting position (3a) wherein said sample collection unit (3) collects at least part of the sample contained in said primary container (100), and retains a volume (V) of said sample; and
   a first releasing position (3b) wherein said sample collection unit (3) releases at least part of the volume (V) of said sample in at least one secondary container or support (102, 103, 104);
wherein the device (1) comprises a data processing unit (4) configured at least for determining the execution, in a substantially automated way, of:
   a control in movement of the sample collection unit (3) between said collecting position (3a) and said at least one first releasing position (3b), and
   an activation of the sample collection unit (3) for carrying out:
      a collection of the volume (V) of the sample contained in said primary container (100), and
      a release of the at least part of said volume (V) in said at least one secondary container or support (102, 103, 104);
wherein the sample collection unit (3) is configured for releasing at least part of the volume (V) of said sample collected in secondary containers or supports (102, 103, 104) of heterogeneous type.

According to another non-limiting aspect, said secondary containers or supports (102, 103, 104) of heterogeneous type comprise at least one first secondary container or support of a first type and/or shape and/or size and at least one second container or support of a second type and/or shape and/or size.

According to another non-limiting aspect, the sample collection unit (3) is configured for releasing at least part of the volume (V) of said sample collected in at least one first secondary container or support of a first type and/or shape and/or size and in at least one second container or support of a second type and/or shape and/or size.

According to another non-limiting aspect, the device (1) comprises a tagging unit (30) configured for applying at least one tag (100k) on at least one between said at least one primary container (100) and/or a secondary container or support (102, 103, 104).

According to another non-limiting aspect, the tagging unit (30) comprises a tag applying tool (100k) and is configured for applying said tag (100k) by means of at least one movement of relative rotation occurring between said at least one between said at least one primary container (100) and/or a secondary container or support (102, 103, 104) and said tag applying tool (100k).

According to another non-limiting aspect, the data processing unit (4) is configured for activating the tagging unit (30) before the activation of said sample collection unit (3) and/or before the control in movement of the sample collection unit (3) such that the tagging of said at least one secondary container or support (102, 103, 104) occurs on at least one secondary container or support (102, 103, 104) empty and/or free from said at least part of said volume (V) released by the sample collection unit (3), or for activating the tagging unit (30) after the activation of said sample collection unit (3) and/or after the control in movement of the sample collection unit (3) such that the tagging of said at least one secondary container or support (102, 103, 104) occurs on at least one secondary container or support (102, 103, 104) at least partially filled and/or provided with said at least part of said volume (V) released by the sample collection unit (3).

According to another non-limiting aspect, the tagging unit (30) comprises at least one printer, configured for printing at least one code, on said tag (100k).

According to another non-limiting aspect, said code comprises at least a first part, optionally a first part and a second part, said second part being different from said first part.

According to another non-limiting aspect, said first part corresponds to a code, or to a corresponding first part of a code, electronically retrieved on a tag of said at least one primary container (100).

According to another non-limiting aspect, the tagging unit (30) is configured for activating said printer for printing a plurality of tags on a respective plurality of secondary containers or supports (102, 103, 104) in such a way that said plurality of tags contains codes having, each one, a first common part, in particular a first part corresponding to said code or said first part of code electronically retrieved by the tag of said at least one primary container (100), and having, each one, a second univocal part, different for each secondary container or support of said plurality of secondary containers or supports (102, 103, 104).

According to the present disclosure is described a method for the collection and the handling of samples, preferably biological, microbiological or chemical samples, from a primary container (100), the method comprising:
a positioning of at least one container (100) for samples in correspondence of at least one support (2) configured for retaining at least one between a primary container (100) and/or a secondary container or support (102, 103, 104) in a predefined position;
a movement of a sample collection unit (3) between at least:
   a collecting position (3a) wherein said sample collection unit (3) collects at least part of the sample contained in said primary container (100), and retains a volume (V) of said sample; and
   a first releasing position (3b) wherein said sample collection unit (3) releases at least part of the volume (V) of said sample in at least one secondary container or support (102, 103, 104);
an activation of the sample collection unit (3) for carrying out:
   a collection of the volume (V) of the sample contained in said primary container (100), and
   a release of the at least part of said volume (V) in said at least one secondary container or support (102, 103, 104).

According to the present disclosure is described a method for the collection and the handling of samples, preferably biological, microbiological or chemical samples, from a primary container (100), the method comprising:
a positioning of at least one container (100) for samples in correspondence of at least one support (2) configured for retaining at least one between a primary container (100) and/or a secondary container or support (102, 103, 104) in a predefined position;
a movement of a sample collection unit (3) between at least:
   a collecting position (3a) wherein said sample collection unit (3) collects at least part of the sample contained in said primary container (100), and retains a volume (V) of said sample; and
   a first releasing position (3b) wherein said sample collection unit (3) releases at least part of the volume (V) of said sample in at least one secondary container or support (102, 103, 104);
an activation of the sample collection unit (3) for carrying out:
   a collection of the volume (V) of the sample contained in said primary container (100), and
   a release of the at least part of said volume (V) in said at least one secondary container or support (102, 103, 104);
the method further comprising an activation of a handling unit (5), for carrying out at least an opening and/or a closing of a stopper (100t) of said primary container (100) configured for being removably coupled to a body (100b) of said primary container (100);
and wherein the handling unit (5) is configured and specifically destined to open and/or close stoppers (100t) and/or bodies (100b) of different size and/or shape.

According to another non-limiting aspect, the assembly formed by the support (2) and by the handling unit (5) adapts in a substantially automatic way at least at the opening and/or closing of:
at least one first stopper (100t) of a first primary container (100), and
at least one second stopper (100t) of a second primary container (100).

According to another non-limiting aspect, the first and the second primary container (100) differ in correspondence of said first and respectively second stopper (100t), for type and/or shape and/or size or the first and the second primary container (100) differ in correspondence of said body (100b) for type and/or shape and/or size.

According to another non-limiting aspect, the activation, in a substantially automated way, of said handling unit (5) comprises a substantially automatic adaptation of said handling unit (5) at least at the opening and/or closing of:
at least one first stopper (100t) of a first primary container (100), and
at least one second stopper (100t) of a second primary container (100).

According to another non-limiting aspect, the method comprises directly contacting the stopper (100t) of said primary container (100) and/or said first stopper (100t) of said first primary container (100) and said second stopper (100t) of said second primary container (100).

According to another non-limiting aspect, the activation, in a substantially automated way, of said handling unit (5), for at least the unscrewing of said stopper (100t), occurs before the activation of the sample collection unit (3) or occurs in substantial temporal simultaneity with the activation of the sample collection unit (3) and/or with the movement of the sample collection unit (3).

According to another non-limiting aspect, the activation of said handling unit (5) causes at least the opening of said stopper (100t) when said primary container (100) is in said collecting position (3a).

According to another non-limiting aspect, the activation of said handling unit (5) causes a separation of said stopper (100t) from said body (100b) when in said collecting position (3a).

According to another non-limiting aspect, the activation of said handling unit (5) causes the opening of said stopper (100t) by means of at least one between a movement of rotation and translation and preferably by means of a combined and simultaneous movement of rototranslation.

According to another non-limiting aspect, the activation of said handling unit (5) causes the activation of at least one gripper (5p) of said handling unit (5) and determines a contact, by said gripper (5p), of a surface, preferably outer, of said stopper (100t).

According to another non-limiting aspect, the activation of said handling unit (5) causes a retaining of said surface, at least during the opening and the separation of the stopper (100t) from the body (100b) preventing a relative rotation of said stopper (100t) with respect to said gripper (5p) and/or preventing a relative translation between said stopper (100t) and said gripper (5p).

According to another non-limiting aspect, the activation of said at least one gripper (5p) determines a movement thereof between at least:
a distanced position with respect to said stopper (100t),
a contact position with said stopper (100t).

According to another non-limiting aspect, the activation of said handling unit (5) causes a movement of said gripper (5p) between said distanced position and said contact position when said gripper (5p) is radially aligned to said stopper (100t).

According to another non-limiting aspect, said sample collection unit (3) and/or said handling unit (5) are arranged at a height higher with respect to a height at which lies said support (2).

According to another non-limiting aspect, the distanced position with respect to said stopper (100t) and the contact position with said stopper (100t) are both at a same height with respect to said support (2).

According to another non-limiting aspect, the sample collection unit (3) releases at least part of the volume (V) of said sample collected in secondary containers or supports (102, 103, 104) of heterogeneous type.

According to another non-limiting aspect, the movement of the sample collection unit (3) occurs between at least the collecting position (3a) and/or the first releasing position (3b) and a second releasing position (3b′).

According to another non-limiting aspect:
in said first releasing position (3b) said sample collection unit (3) releases at least a first part of the volume (V) of said sample collected in a first secondary container or support (102);
in said second releasing position (3b′) said sample collection unit (3) releases at least one second part of the volume (V) of said sample collected in at least one second secondary container or support (103,104).

According to another non-limiting aspect, the movement of the sample collection unit (3) occurs automatically from the collecting position (3a) to the first releasing position (3b) and, subsequently, from the first releasing position (3b) to the second releasing position (3b′).

According to another non-limiting aspect, said sample collection unit (3) comprises, or is, a pipetting unit.

According to another non-limiting aspect, said sample collection unit (3) comprises a sample collection element in form of a hollow tip and the method comprises retaining at least said volume (V) of said sample by means of said hollow tip.

According to another non-limiting aspect, said hollow tip is configured for being removably connected to a support for tips of said sample collection unit (3).

According to another non-limiting aspect, the method comprises sucking or pushing at least part of said volume (V) of said sample respectively inside or outside of said hollow tip by means of a pump of said sample collection unit (3), operatively connected to said hollow tip.

According to another non-limiting aspect, the method comprises activating the sample collection unit (3) for causing a movement of an actuator of said pump, and determining said volume (V) of said sample collected from said primary container (100) or at least partially released in said at least one secondary container or support (102, 103, 104) and/or sucked or pushed respectively inside or outside of said hollow tip in function of the movement of said actuator.

According to another non-limiting aspect, the method comprises detecting a volume of sample present within said hollow tip by means of a volume sensor positioned on at least one between the sample collection unit (3) and/or said hollow tip.

According to another non-limiting aspect, the method comprises transmitting, starting from said volume sensor, a control signal having a value function of said volume of sample present within said hollow tip.

According to another non-limiting aspect, a determination of said volume (V) of said sample collected from said primary container (100) or at least partially released in said at least one secondary container or support (102, 103, 104) and/or sucked or pushed respectively inside or outside of said hollow tip occurs in function of the control signal provided by said volume sensor.

According to another non-limiting aspect, the sample collection unit (3) is a pipetting unit.

According to another non-limiting aspect, the method comprises the activation of at least one pump of said pipetting unit, for a sucking and/or controlled release of said volume (V) of said sample.

According to another non-limiting aspect, the method comprises supporting a sample collection element (3p) in correspondence of a support of said sample collection unit (3).

According to another non-limiting aspect, said sample collection element (3p) comprises a loop and/or a spoon and/or a cylinder and/or a collection ring and/or a hollow tip.

According to another non-limiting aspect, the method comprises a removable connection of said sample collection element (3p) in correspondence of said support.

According to another non-limiting aspect, said sample collection element (3p) is of disposable type.

According to another non-limiting aspect, the method comprises connecting said hollow tip to said at least one pump for allowing the collection and the retaining of said volume (V) of said sample.

According to another non-limiting aspect, the method comprises transferring said sample collection element (3p) in a disposal unit for said sample collection element (3p).

According to another non-limiting aspect, the method comprises transferring or determining the transfer of the sample collection element (3p) from the support to a disposal container of said disposal unit, through a duct or discharging hopper (3k) connected to said disposal container.

According to another non-limiting aspect, the method comprises letting fall said sample collection element (3p) in said disposal container (3c) placed under said duct or discharging hopper (3k).

According to another non-limiting aspect, the method comprises arranging at least two between said collecting position (3a), said first releasing position (3b) and said second releasing position (3b′) at a same height. According to another non-limiting aspect, the method comprises actuating in a substantially automated way a control in movement of the sample collection unit (3) from the collecting position (3a) to the first releasing position (3b) by means of a composite movement comprising:
a raising of the height from a first lower height to a second higher height,
a translation along a plane, when at a height different with respect to said first lower height, in particular when at said second higher height.

According to another non-limiting aspect, the method comprises a step of activation of at least one between a centrifugation unit (6) and an agitation unit (7) for said at least one primary container (100) and/or said secondary container or support (102, 103, 104).

According to another non-limiting aspect, the step of activation comprises:
a centrifugation, by means of said centrifugation unit (6), of said primary container (100) and/or of said secondary container or support (102, 103, 104) pushing by centrifugal force a part of the sample within a predefined portion, optionally a bottom portion, of said at least one primary container (100) and/or of said secondary container or support (102, 103, 104); and/or
an agitation, by means of said agitation unit (7), of said sample contained in said primary container (100) and/or in said secondary container or support (102, 103, 104) preferably moving, by means of said agitation unit (7), said primary container (100) and/or said secondary container or support (102, 103, 104) on a movement of rotation eccentric with respect to a reference axis (K).

According to another non-limiting aspect, the activation of said centrifugation unit (6) and/or of said agitation unit (7) occurs in a predefined temporal sequence with respect to the activation of said sample collection unit (3), optionally the activation of said centrifugation unit (6) and/or of said agitation unit (7) occurring before the activation of said sample collection unit (3).

According to another non-limiting aspect, at least one between said agitation unit (7) and said centrifugation unit (6) is positioned in substantial correspondence of said support (2).

According to another non-limiting aspect, said centrifugation unit (6) is positioned in substantial correspondence of said support (2) and the centrifugation unit (6) is positioned remotely with respect to said support (2) or is positioned in correspondence of a same support plane (1p) on which lies or is installed the support (2).

According to another non-limiting aspect, the method comprises housing and retaining said primary container (100) and/or said secondary container or support (102, 103, 104) during its centrifugation in a secondary support (6s) of said centrifugation unit (6).

According to another non-limiting aspect, the method comprises a step of movement, with said handling unit (5), of said at least one primary container (100) between said support (2) and said centrifugation unit (6), in particular said secondary support (6s), by means of a predefined movement, preferably composite of rotation, of translation or of rototranslation.

According to another non-limiting aspect, the movement, with said handling unit (5) of said at least one primary container (100) between said support (2) and said centrifugation unit (6) occurs retaining by means of said handling unit (5) said at least one primary container in correspondence of a predefined retaining position, preferably in correspondence of said stopper (100t).

According to another non-limiting aspect, the activation of said handling unit (5) for moving said at least one primary container (100) between said support (2) and said centrifugation unit (6) occurs in a predefined temporal sequence with respect to the activation of said sample collection unit (3), and optionally occurs before the activation of said sample collection unit (3).

According to another non-limiting aspect, the activation of at least one gripper (5p) of said handling unit (5) determines a contact, by said gripper (5p), of a surface, preferably outer, of said stopper (100t) and a retaining of said surface, at least during the movement of said primary container (100) between said support (2) and said centrifugation unit (6).

According to another non-limiting aspect, the method comprises a step of feeding of at least a substance, preferably fluid, by means of at least one filling unit (8, 8′), comprising at least one duct (8c, 8c′) of feeding of said at least a substance, said feeding occurring preferably within at least one between said at least one primary container (100) and said secondary container or support (102, 103, 104).

According to another non-limiting aspect, the step of feeding determines a rehydration and/or dilution and/or a lysis and/or a reaction of a sample contained in said at least one between said at least one primary container (100) and said secondary container or support (102, 103, 104).

According to another non-limiting aspect, the step of feeding determines, by means of said at least one filling unit (8, 8′), the feeding of a controlled volume of said at least a substance in said at least one primary container (100) when said primary container (100) is in correspondence of said support (2) and/or in said secondary container or support (102, 103, 104) when said secondary container or support (102, 103, 104) is in correspondence of said support (2).

According to another non-limiting aspect, the step of feeding comprises the activation of a pump (8p) of said at least one filling unit (8, 8′), optionally an occlusive pump, operatively connected to said duct (8c, 8c′).

According to another non-limiting aspect, said at least one duct (8c, 8c′) is of flexible and/or compressible type and the activation of said occlusive pump determines a compression of said duct, determining said feeding of said controlled volume of said at least a substance within said at least one between said at least one primary container (100) and said secondary container or support (102, 103, 104).

According to another non-limiting aspect, the method comprises a step of extraction of said substance from at least one tank (8k, 8k′) of said filling unit, said tank (8k, 8k′) being removably connected to said duct (8c, 8c′). According to another non-limiting aspect, said tank (8k, 8k′) is substantially floppy and/or compressible.

According to another non-limiting aspect, said tank (8k, 8k′) is substantially rigid, and is preferably realized in plastic or vitreous material.

According to another non-limiting aspect, the extraction of said substance determines a deformation of said tank (8k, 8k′) after a progressive emptying from said substance.

According to another non-limiting aspect, the step of feeding of said substance occurs, by means of said at least one filling unit (8, 8′), simultaneously, in a plurality of primary containers (100) or in a plurality of secondary containers or supports (102, 103, 104) or in at least one first primary container (100) and in at least one first secondary container or support (102, 103, 104).

According to another non-limiting aspect, the method comprises a step of activation of a movable actuator (8m, 8m′) of said at least one filling unit (8, 8′), wherein the movable actuator (8m, 8m′) is connected to a predefined portion, preferably an ending portion, of said duct (8c, 8c′).

According to another non-limiting aspect, the step of activation of a movable actuator (8m, 8m′) determines the movement thereof at least between:
a first operating position wherein said predefined portion, preferably said ending portion, of said duct (8c, 8c′) is substantially aligned to an opening of said at least one primary container (100) and/or said secondary container or support (102, 103, 104),
a second operating position wherein said predefined portion, preferably said ending portion, of said duct (8c, 8c′) is misaligned with respect to said opening of said at least one primary container (100) and/or secondary container and/or support (102, 103, 104).
   According to another non-limiting aspect, the movement between said first operating position and said second operating position comprises a rotation of said movable actuator (8m, 8m′) around a predefined axis, preferably substantially vertical.

According to another non-limiting aspect, the method comprises:
keeping deactivated said pump (8p) when said movable actuator (8m, 8m′) is in said second operating position;
activating said pump (8p) when said movable actuator (8m, 8m′) is in said first operating position;

and optionally
keeping activated said pump (8p) for a time sufficient to supply a predefined volume of the at least a substance;
deactivating the pump (8p) before the movement of the movable actuator (8m, 8m′) from the first operating position to the second operating position.

According to another non-limiting aspect, the method comprises a step of housing of a plurality of primary containers (100) in at least one first loading station (9, 39).

According to another non-limiting aspect, the method comprises a movement of said handling unit (5) and comprises moving by means of said handling unit (5) at least one primary container (100) from said at least one first loading station (9, 39) to said support (2) by means of a predefined movement, preferably composite of rotation, of translation or of rototranslation.

According to another non-limiting aspect, the housing of said plurality of primary containers (100) in said at least one first loading station (9, 39) comprises housing removably at least one magazine (9c) having a plurality of seats for said primary containers (100) on at least one slide (9s) of said at least one first loading station (9, 39).

According to another non-limiting aspect, said seats are configured for housing, each one, a respective primary container (100).

According to another non-limiting aspect, the housing of said plurality of primary containers (100) in said at least one first loading station (9, 39) comprises housing removably a plurality of magazines (9c) having each one a plurality of seats for said primary containers (100) on a respective plurality of slides (9s) of said at least one first loading station (9, 39).

According to another non-limiting aspect, the method comprises an electronic identification of said at least one magazine (9c) in said at least one first loading station (9, 39), preferably a selective electronic identification of each magazine of said plurality of magazines (9c) in said at least one first loading station (9, 39).

According to another non-limiting aspect, the electronic identification occurs by means of an electronic identification tag (9z) of each magazine of said plurality of magazines (9c) and by means of a reading of electronic data stored in said electronic identification tag (9z) by means of a reader (9r) for said electronic identification tag of said at least one first loading station (9, 39).

According to another non-limiting aspect, the step of housing of said plurality of primary containers (100) in at least one first loading station (9, 39) comprises:
a movement of a primary container (100) from a first starting position to a second arrival position (39e) of a conveyor (39c);
a housing of said plurality of primary containers (100) in at least one magazine (39c) comprising, and/or joined to, at least one singularizer or separator (39b) configured for transferring a primary container (100) of said plurality of primary containers (100) from said magazine (39c) to said first starting position.

According to another non-limiting aspect, the method comprises activating the handling unit (5) for moving at least one primary container (100) from said second arrival position to said support (2) by means of a predefined movement, preferably composite of rotation, of translation or of rototranslation, and for opening and/or closing the stopper (100t) of said primary container (100) when the primary container (100) is in correspondence of said support (2),
or activating the handling unit (5) for opening and/or closing the stopper (100t) of said primary container (100) when the primary container (100) is in said second arrival position (39e), or transferring the primary container (100) from said second arrival position (39e) or from said support (2) to a storage area (39g) of said at least one first loading station (39).

According to another non-limiting aspect, the method comprises a step of housing of a plurality of primary containers (100) in a first loading station (9) and a step of housing of a plurality of primary containers (100) in a second loading station (39), preferably wherein said first loading station (9) is configured for housing a plurality of primary containers (100) of a first type and/or size and/or shape and said second loading station (39) is configured for housing a plurality of primary containers (100) of a second type and/or size and/or shape.

According to another non-limiting aspect, the method comprises a movement of said handling unit (5) for moving, by means of said handling unit (5), at least one primary container (100) from said first loading station (9) to said support (2) by means of a predefined movement, preferably composite, of rotation, of translation or of rototranslation, and for moving, by means of said handling unit (5), at least one primary container (100) from said second loading station (9) to said support (2) by means of a predefined movement, preferably composite, of rotation, of translation or of rototranslation, or for moving, by means of said handling unit (5), at least one primary container (100) from a first position to a second position within said second loading station (39) and/or for opening and/or closing at least one primary container (100) when positioned in said second loading station (39).

According to another non-limiting aspect, the movement of said at least one primary container (100) occurs starting from at least one magazine (9c) of said first loading station (9).

According to another non-limiting aspect, said at least one magazine (9) has a plurality of seats configured for retaining, when housed, a plurality of primary containers (100) in a predefined spatial configuration.

According to another non-limiting aspect, the movement of said at least one primary container (100) occurs starting from at least one magazine (39) of said second loading station (39).

According to another non-limiting aspect, said at least one magazine (39c) is configured for allowing a relative movement between primary containers of said plurality of primary containers (100) when housed herein. According to another non-limiting aspect, the method comprises a step of housing of at least one secondary container or support (102, 103, 104) in at least one releasing station (11) configured for housing a plurality of secondary containers (102, 103, 104), said at least one releasing station (11) being configured for housing secondary containers (102, 103, 104) of different shape and/or size.

According to another non-limiting aspect, said first releasing position (3b) is arranged, optionally said first releasing position and said second releasing position (3b′) are arranged, in correspondence of said at least one releasing station (11).

According to another non-limiting aspect, said method comprises housing at least one secondary container (104) in an auxiliary support (13) arranged in a position different with respect to said releasing station (11).

According to another non-limiting aspect, said first releasing position (3b) is arranged in correspondence of said auxiliary support (13).

According to another non-limiting aspect, the method comprises a movement of said handling unit (5) and moving by means of said handling unit (5) at least one secondary container or support (102, 103, 104) from said auxiliary support (13) to said releasing station (11) and/or moving by means of said handling unit (5) said primary container (100) from said support (2) to said releasing station (11) by means of a predefined movement, preferably composite of rotation, of translation or of rototranslation.

According to another non-limiting aspect, the method comprises activating a conveying unit (12) independently movable with respect to said handling unit (5) and moving by means of said conveying unit (12) at least one secondary container or support (102, 103, 104) from said auxiliary support (13) to said releasing station (11) and/or moving said primary container (100) from said support (2) to said releasing station (11).

According to another non-limiting aspect, the method comprises activating in a simultaneous or alternative way said handling unit (5) and said conveying unit (12), and preferably activating in a simultaneous way the handling unit (5) and the conveying unit (12) and moving respectively at least one primary container (100) from said support (2) to said releasing station (11) by means of said handling unit (5) and moving said at least one secondary container or support (102, 103, 104) from said auxiliary support (13) to said releasing station (11) by means of said conveying unit (12).

According to another non-limiting aspect, the method comprises housing a plurality of secondary containers (102, 103 ,104) in a plurality of seats of a magazine (11c) housed removably on a slide (11s) of said releasing station (11).

According to another non-limiting aspect, said seats are suitable for housing, each one, a respective secondary container or support (102, 103, 104).

According to another non-limiting aspect, said method comprises housing a plurality of said magazines (11c) in a respective plurality of slides (11s) of said releasing station (11).

According to another non-limiting aspect, said plurality of slides (11s) allows the independent introduction and/or extraction of a respective magazine (11c).

According to another non-limiting aspect, said method comprises an automatic movement of said handling unit (5) and/or of said conveying unit (12) and comprises moving by means of said handling unit (5) and/or said conveying unit (12) at least one secondary container or support (102, 103, 104) from said auxiliary support (13) to said releasing station (11) and/or moving by means of said handling unit (5) and/or said conveying unit (12) said primary container (100) from said support (2) to said releasing station (11) after said control in movement of the sample collection unit (3) from the collecting position (3a) to the first releasing position (3b) and, optionally, from the first releasing position (3b) to the second releasing position (3b′).

According to another non-limiting aspect, said at least one magazine (9c) comprises at least one first seat for a first primary container (100) and a second seat for a second primary container (100).

According to another non-limiting aspect, the activation, in a substantially automated way, of said handling unit (5), causes:
a movement of the handling unit (5) in correspondence of the first seat of the magazine (9c),
an extraction from the first seat of the magazine (9c) of at least one first primary container (100);
a transport of said at least one first primary container (100) from the first seat of the magazine (9c) towards a position different with respect to a position of said first seat, preferably towards said support (2);
a drawing of said at least one first primary container (100) from the support (2);
a movement of the handling unit (5) in correspondence of the first seat of the magazine (9c);
a deposit of said at least one first primary container (100) in said first seat of the magazine (9c), and subsequently,
a movement of the handling unit (5) from the first seat to the second seat of the magazine (9c),
preferably, the movement of the sample collection unit (3) occurring after said transport of said at least one first primary container (100) from the first seat of the magazine (9c) towards said position different with respect to a position of said first seat.

According to another non-limiting aspect, the method comprises a step of fracturation, by means of a fracturation unit, of a predetermined portion (U) of an elongated body (100d) of a swab (100c) joined to the stopper (100t) of said primary container (100).

According to another non-limiting aspect, the step of fracturation causes a permanence of a collecting portion (100e) joined to said elongated body (100d) within said primary container (100) after the fracture.

According to another non-limiting aspect, the step of fracturation comprises the movement of said stopper (100t) with respect to a body (100b) of said primary container (100) for causing said fracturation, more preferably wherein said step of fracturation comprises translating said stopper (100t) with respect to said body (100b).

According to another non-limiting aspect, the method comprises make the elongated body (100d) of said swab (100c) interfere with said body (100b) of the primary container (100), preferably in substantial correspondence of said predetermined portion (U), for carrying out said fracturation.

According to another non-limiting aspect, said step of fracturation occurs by means of said handling unit (5). According to another non-limiting aspect, the activation of the sample collection unit (3) occurs after said step of fracturation.

According to the present disclosure is further described a method for the collection of samples, preferably biological, microbiological or chemical samples, from a primary container (100), the method comprising:
a positioning of at least one container (100) for samples in correspondence of at least one support (2) configured for retaining said at least one between an at least one primary container (100) and at least one secondary container or support (102, 103, 104) in a predefined position;
a movement of a sample collection unit (3) between at least:
   a collecting position (3a) wherein said sample collection unit (3) collects at least part of the sample contained in said primary container (100), and retains a volume (V) of said sample; and
   a first releasing position (3b) wherein said sample collection unit (3) releases at least part of the volume (V) of said sample in at least one secondary container or support (102, 103, 104);
an activation of the sample collection unit (3) for carrying out:
   a collection of the volume (V) of the sample contained in said primary container (100), and
   a release of the at least part of said volume (V) in said at least one secondary container or support (102, 103, 104);
the method comprising a step of feeding of at least a substance, preferably fluid, by means of at least one filling unit (8), comprising at least one feeding duct (8c, 8c′) of said at least a substance, said feeding occurring preferably within at least one between said at least one primary container (100) and said secondary container or support (102, 103, 104);
wherein the method comprises a step of extraction of said substance from at least one tank (8k) of said filling unit and, preferably removably, connected to said duct (8c, 8c′), and/or wherein the step of feeding of said substance occurs, by means of said at least one filling unit (8, 8′), preferably simultaneously, in a plurality of primary containers (100) or in a plurality of secondary containers or supports (102, 103, 104) or in at least one first primary container (100) and in at least one first secondary container or support (102, 103, 104).

According to another non-limiting aspect, said tank (8k) is substantially floppy and/or compressible, and preferably the extraction of said substance determines a deformation of said tank (8k) after a progressive emptying from said substance.

According to another non-limiting aspect, said tank (8k, 8k′) is substantially rigid, and is preferably realized in plastic or vitreous material.

According to the present disclosure is further described a method for the collection and the handling of samples, preferably biological, microbiological or chemical samples, from a primary container (100), the method comprising:
a positioning of at least one container (100) for samples in correspondence of at least one support (2) configured for retaining at least one between a primary container (100) and/or a secondary container or support (102, 103, 104) in a predefined position;
a movement of a sample collection unit (3) between at least:
   a collecting position (3a) wherein said sample collection unit (3) collects at least part of the sample contained in said primary container (100), and retains a volume (V) of said sample; and
   a first releasing position (3b) wherein said sample collection unit (3) releases at least part of the volume (V) of said sample in at least one secondary container or support (102, 103, 104);
an activation of the sample collection unit (3) for carrying out:
   a collection of the volume (V) of the sample contained in said primary container (100), and
   a release of the at least part of said volume (V) in said at least one secondary container or support (102, 103, 104);
wherein the sample collection unit (3) releases at least part of the volume (V) of said sample collected in secondary containers or supports (102, 103, 104) of heterogeneous type.

According to another non-limiting aspect, the sample collection unit (3) releases at least part of the volume (V) of said sample collected in at least one first secondary container or support of a first type and/or having a first size and/or shape and releases at least part of the volume (V) of said sample collected in at least one second secondary container or support of a second type and/or having a second size and/or shape.

According to another non-limiting aspect, the method comprises a step of activation of a tagging unit (30) and of applying, by means of said tagging unit (30), of at least a tag on at least one between said at least one primary container (100) and/or a secondary container or support (102, 103, 104).

According to another non-limiting aspect, the step of applying of said at least a tag comprises the actuation of a tag applying tool (100k) of said tagging unit (30) and an applying of said tag (100k) by means of at least one movement of relative rotation occurring between said at least one between said at least one primary container (100) and/or a secondary container or support (102, 103, 104) and said tag applying tool (100k).

According to another non-limiting aspect, the method comprises activating the tagging unit (30) before the activation of said sample collection unit (3) and/or before the control in movement of the sample collection unit (3) in such a way that the tagging of said at least one secondary container or support (102, 103, 104) occurs on at least one secondary container or support (102, 103, 104) empty and/or free from said at least part of said volume (V) released by the sample collection unit (3), or activating the tagging unit (30) after the activation of said sample collection unit (3) and/or after the control in movement of the sample collection unit (3) such that the tagging of said at least one secondary container or support (102, 103, 104) occurs on at least one secondary container or support (102, 103, 104) at least partially filled and/or provided with said at least part of said volume (V) released by the sample collection unit (3).

According to another non-limiting aspect, the method comprises an activation of at least one printer of said tagging unit (30) for printing, by means of said printer, at least one code on said tag (100k).

According to another non-limiting aspect, said code comprises at least a first part, optionally a first part and a second part, said second part being different from said first part.

According to another non-limiting aspect, said first part corresponds to a code, or to a corresponding first part of a code, electronically retrieved on a tag of said at least one primary container (100).

According to another non-limiting aspect, the method comprises a step of electronic retrieval of said code, or of said first part of said code, by the tag of said at least one primary container (100).

According to another non-limiting aspect, the method comprises activating said printer for printing a plurality of tags on a respective plurality of secondary containers or supports (102, 103, 104) in such a way that said plurality of tags contains codes having, each one, a first common part, in particular a first part corresponding to said code or said first part of code electronically retrieved by the tag of said at least one primary container (100), and having, each one, a second univocal part, different for each secondary container or support of said plurality of secondary containers or supports (102, 103, 104).

According to the present disclosure is described a computer program, stored on a memory support; said computer program comprising software code portions that, when executed from at least one data processing unit, cause the execution of the method according to one or more of the aspects herein described.

According to the present disclosure is described a use of the device according to one or more of the aspects herein described for forensic applications and/or for analysis of samples of urine and/or fecal and/or blood, and/or for the execution of a pathogen screening, preferably of the respiratory, genital, urinary and/or gastrointestinal tracts, or for the execution of Papilloma Virus (HPV) screening and/or for the detection, and/or processing, of samples of blood or plasma, or proteins.

According to another non-limiting aspect, said samples are collected by means of a swab from at least one predefined part of the human or animal body, or are collected by means of a swab from a natural or artificial surface or environment.

### FIGURES

The object of the present disclosure will be described in some of its preferred and non-limiting embodiments that refer to the attached figures. A brief description of the figures is provided hereinafter.

FIG. 1 shows a front view of the device object of the present disclosure.

FIG. 2 shows a lateral view of the device object of the present disclosure.

FIG. 3 shows a plant view of a main support plane, wherein different units suitable for manipulating a plurality of containers are present.

FIG. 4 shows a schematic view of a support for a primary container.

FIG. 5 shows a detailed view of a handling unit of the device object of the present disclosure.

FIG. 6 shows an alternative configuration of the handling unit and of the support for the primary container.

FIG. 7 shows a schematic view of an agitation unit.

FIG. 8 shows a perspective view of the device object of the present disclosure, wherein is also visible a loading station and a filling unit.

FIG. 9 shows a perspective view of part of the filling unit; in FIG. 5 a movable actuator of the filling unit is arranged in a first position.

FIG. 10 shows a perspective view of part of the filling unit; in FIG. 6 a movable actuator of the filling unit is arranged in a second position.

FIG. 11 shows a perspective view of a releasing station of the device object of the present disclosure.

FIG. 12 shows a perspective view of a unit of movement specifically configured for determining the fracturation of a portion of a swab.

FIG. 13 shows a detailed view of part of a loading station wherein the magazines for primary containers are provided with RFID tag.

### DETAILED DESCRIPTION

### General Aspect

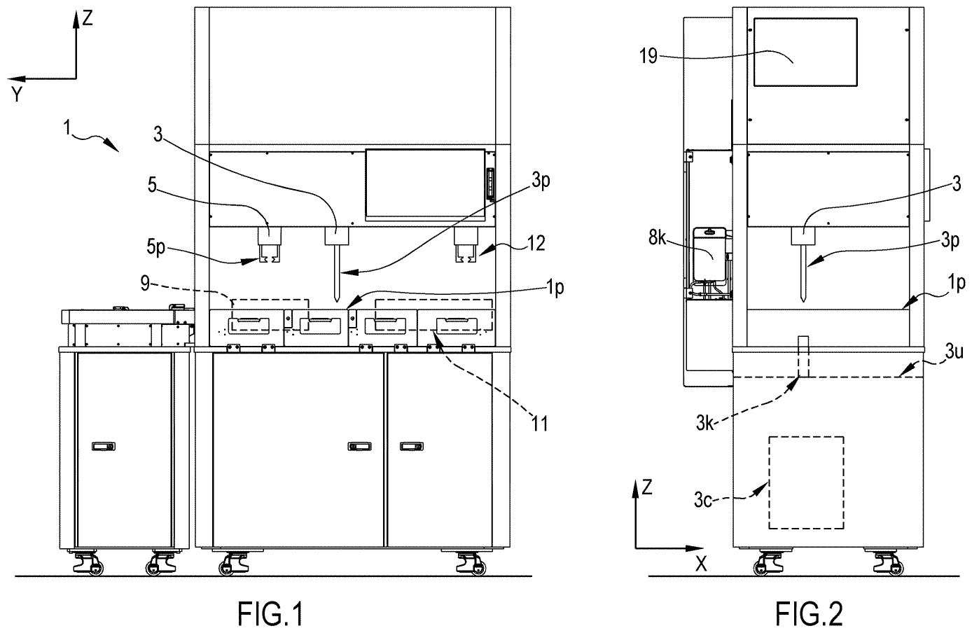

The device 1 for the collection and handling of samples, in the preferred embodiment, is a device of a floor standing type. As schematically represented in FIGS. 1 and 2, the device 1 herein described comprises a support frame that supports a main support plane 1p at a predefined height with respect to the ground. The device 1 can be provided with wheels for the movement or, alternatively, be provided with feet if it is intended to arrange the above-mentioned device in a position fixed to the ground.

The device 1, by means of the support frame, detects a working volume B within which is positioned at least part of, preferably the most of, the components herein described below.

The working volume B can be ideally limited on the borders of the support frame or be physically limited by walls of the device 1, that may be present or absent in correspondence of the above-mentioned working volume.

Inferiorly a main support plane 1p delimits the working volume B.

In a preferred but non-limiting embodiment, the main support plane 1p is arranged at a predefined height with respect to the ground; however, it is conceivable that the main support plane 1p can be adjusted in height.

### Working Environment

The working volume B defined from the support frame, and that is above the main support plane 1p, can be a controlled environment working volume. In particular the device 1 can comprise an air conditioning unit 19, configured for carrying out-preferably in an automatic way under the control of the data processing unit 4 and/or alternatively with manual control-one between the following technical functions:
a filtering, at least of primary type (or pre-filtering) of the air by means of dust filters and/or by electrostatic way, carried out to remove the gross part of air dust or impurities, and/or of secondary type (absolute);
forcing the variation or the keeping of the temperature and/or humidity of the air contained in the working volume B;
forcing the variation or the keeping of a predefined pressure within the working volume B.

In the embodiments shown in the attached figures, which should not be considered as limiting, the air-conditioning unit 19 is placed in an upper ending portion of the device 1, above the working volume B.

In a preferred embodiment, the air conditioning unit 19 is configured and specifically destined to allow the induction of an air laminar flow inside the working volume B. Preferably, this air laminar flow is directed from above toward the bottom. The air laminar flow is directed at least in correspondence of areas of the working volume where it is present the sample collection unit 3 and/or the handling unit 5, that are better described hereinafter. The effect of the air laminar flow is to contain the dispersion of pathogens and/or parts of the sample within the above-mentioned volume B.

The air laminar flow is filtered from the filter of the air conditioning unit 19.

Getting into the technical detail, and in particular way when the device 1 is configured for operating with samples at significant biosafety risk, the filter installed on board of the conditioning unit 19, in particular to perform the secondary filtration, is a HEPA filter, preferably a filter of efficiency equal to or higher than E12 according to EN 1822-1 2019 or ISO20E according to ISO29463-1 2017.

In an embodiment, at least the working volume B is isolated so as to ensure standard according to BSL-2, and then an embodiment of the device 1 respects the standard BSL-2.

On the main support plane 1p can be present holes 1f, in particular arranged according to a predefined pattern, configured alternately or in combination for:
allowing to position one or more units of the device 1 in a plurality of relative positions, allowing flexibility of positioning and/or re-positioning of the units on the plane;
allowing the sucking of air by the air conditioning unit contained in the working volume B.

### The Base Configuration of the Device

The device 1 is configured and specifically destined to manipulate samples and/or collecting samples, preferably biological, microbiological or chemical samples, from a primary container 100.

For the purposes of the present disclosure, chemical samples are nonbiological and nonmicrobiological samples including for example nonorganic or organic substances in solid, gel, liquid or at least partially gaseous form. When in solid shape these substances may be for example in powdery form, in grains, in flakes.

Biological or microbiological samples may be of human origin, in particular collected within the body of a human being, or they may be of animal origin, or of plant origin.

Biological or microbiological samples, as well as samples non-biological or microbiological chemical samples, can be collected from urban and/or natural environments.

As schematically represented in FIGS. 1, 2, and 3, the device 1 comprises:
at least one support 2 configured for retaining at least one primary container 100 in a predefined position;
at least a sample collection unit 3, movable between at least:
   a collecting position 3a wherein said sample collection unit 3 collects at least part of the sample contained in the primary container 100, and retains a volume V of said sample; and
   a first releasing position 3b wherein said sample collection unit 3 releases at least part of the volume V of the sample in at least one secondary container or support 102, 103, 104.

The device 1 comprises a data processing unit 4 configured at least for determining the execution, in a substantially automated way, di:
a control in movement of the sample collection unit 3 between the collecting position 3a and the at least one first releasing position 3b, and
an activation of the sample collection unit 3 for carrying out:
   a collection of the volume V of the sample contained in said primary container 100, and
   a release of the at least part of said volume V in said at least one secondary container or support 102, 103, 104.

Thanks to these technical characteristics it is possible to process in a short time a large amount of samples reducing as much as possible the presence of a specialized user for the handling of the above-mentioned samples.

The automated handling of samples in terms of their at least partial collection from the primary container reduces the risk of mishandling by the user, of an exchange of samples, of contaminations and therefore increases the reliability of the analyses that are subsequently carried out on the samples themselves.

The device 1 object of the present disclosure can be operated at high speed and manipulate a large number of samples; in this way, the device 1 according to the present disclosure is particularly useful for carrying out tests on high volumes of samples, for example, for mass screening for applications such as, for example, detection of HPV or respiratory, genital, urinary and/or gastrointestinal pathogens, for the detection of the presence, or for the processing, of blood or plasma or proteins.

### The Primary Container

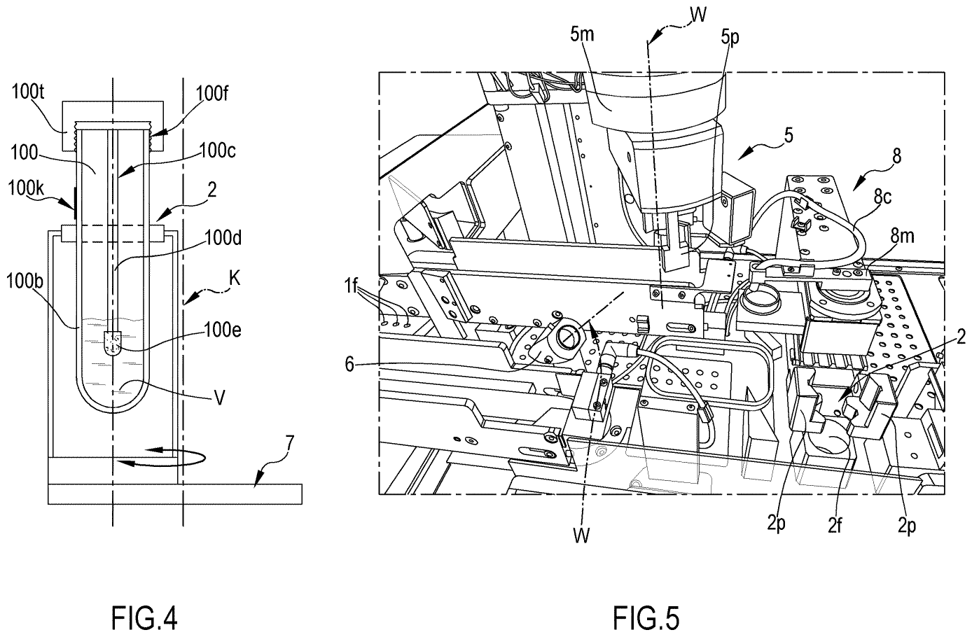

As schematically represented in FIG. 4, the primary container 100 is a container configured for containing samples preferably of biological or microbiological type. In particular, the primary container 100 is a container in which the user, or the medical or paramedical specialist, collects the sample of biological or microbiological material. In an embodiment that should not be intended in a limiting way, the primary container can comprise a body 100b in the shape of a test tube with a substantially circular transversal section, provided with a convex bottom and realized for example in a plastic or glass material (es. Pyrex, Jena, borosilicate glass Schott Duran).

If the primary container 100 assumes a shape of a test tube, the body 100b is a main body, i.e. with respect to the stopper 100t assumes a larger size.

Preferably, but non-limiting thereto, the primary container 100 is provided with a stopper 100t. In a non-limiting embodiment, the stopper 100t is configured for being screwed on the primary container 100. More in particular, the stopper 100t is configured for being screwed on a thread 100f realized on a head portion of the primary container 100, where it is present an opening.

Alternatively, the stopper 100t can be a stopper inserted in an ending portion of the primary container 100 by means of friction coupling. In this case the stopper 100t can be realized in a significantly deformable material, and in particular with marked elastic property.

The stopper 100t when properly connected to the body 100b of the primary container 100 (closed) is destined to isolate the environment (volume) of the primary container 100 to prevent the escape of dusts, liquids and/or gases possibly contained therein, and thus to prevent, in the field of biological handling, the escape of samples contaminated with e.g. viruses, bacteria, fungi, molds, etc.

The primary container 100 can be configured and specifically destined to contain within it a swab for the collection of biological and/or microbiological and/or chemical material, or a sub-container for this material.

The elongated shape of the primary container 100 can be such as to allow to house a swab that presents an elongated body with a stem shape the end of which houses a collecting portion.

Non-limiting examples of plastic materials that can be used for the partial or integral production of the primary container include:
polyester and derivatives, for example polybutylene terephthalate (PBT) or polyethylene terephthalate (PET);
polyether ether ketone (PEEK);
polyphenylenesulfide (PPS);
acrylonitrile butadiene styrene (ABS);
polyurethane (PU);
polyvinylchloride (PVC);
polymethylmethacrylate (PMMA);
high-or low-density polyester (HDPE, LDPE);
polycarbonate;
polystyrene;
polyamide, in particular aliphatic polyamide, for example Nylon.

Plastic materials usable for the realization of the primary container 100 can be either of thermoplastic type or thermosetting type (for example, PU).

The collecting portion of the swab is for example and non-limiting thereto configured and specifically destined to allow the collection of at least 40 ml, or 50 ml, or 70 ml, or 100 ml. This is in particular valid where the collecting portion can be in form of sub-container. Where the collecting portion is of swab type, in particular flocked, typical quantities of samples, preferably fluids, that are collected may reach 50 μl or 70 μl, or 100 μl or up to 150 μl.

In a specific embodiment, the collecting portion of the swab, can be pre-imbibed or impregnated with a substance, in particular with a reagent. This reagent, alternatively or in combination with the above described, can be in principle contained within the primary container 100.

As schematically shown in FIG. 4, in a non-limiting embodiment, the swab 100c presents an elongated body 100d that extends between the stopper 100t and the collecting portion 100e of the swab itself.

As will be better explained in the following portions of the description, the swab can be fractured in a predetermined portion of the elongated body 100d in order to allow to keep at least part of the swab 100c in the primary container 100 during the various operations executed from the device 1. The fracture occurs by means of a fracturation unit that is better described in the following description portion.

In an embodiment the primary container 100 comprises a tag 100k, the quale comprises an alphanumeric or visual code capable of being read by an optical reader. The tag 100k is positioned preferably on the body 100b, ma in another embodiment can also be arranged on the stopper 100t.

### The Support for the Primary Container

The support 2 for the primary container 100 is destined to house a predefined portion, preferably a predefined lower portion, of the primary container 100. In an embodiment, that should not be considered limiting, the lower portion of the primary container 100 can be housed in a boring, e.g., blind, indicated with the reference 2f. The boring 2f preferably detects a shape geometrically similar to the one detected by the transversal section of the primary container 100, although of larger size.

Preferably, but non-limiting thereto, this support 2 comprises a hole of housing and a movable gripper that allows to retain the primary container 100 by preventing the rotation. Thanks to this technical characteristic it is possible to force the relative rotation of the stopper 100t with respect to the body 100b retaining the latter in a fixed position with said movable gripper 2p and forcing the relative rotation of the stopper 100t with respect to the body 100b by means of a handling unit 5, that will be better described in the following portions of the description.

In a preferred embodiment, the gripper 2p comprises two opposed claws that move radially with respect to a central position between at least one distanced position with respect to the lateral wall of the body 100b of the primary container 100, and a contact position with said lateral wall.

In the distanced position, the two opposed claws are at a distance greater with respect to the distance to which they are when in contact with said lateral wall.

In a non-limiting embodiment, the claws have an internally concave profile that detects at an angular point.

In use, the data processing unit 4 controls the automated movement of said gripper, in particular by forcing the closing against the lateral wall when the handling unit 5 has deposited the main container 100 at a correct height on the or in the support 2.

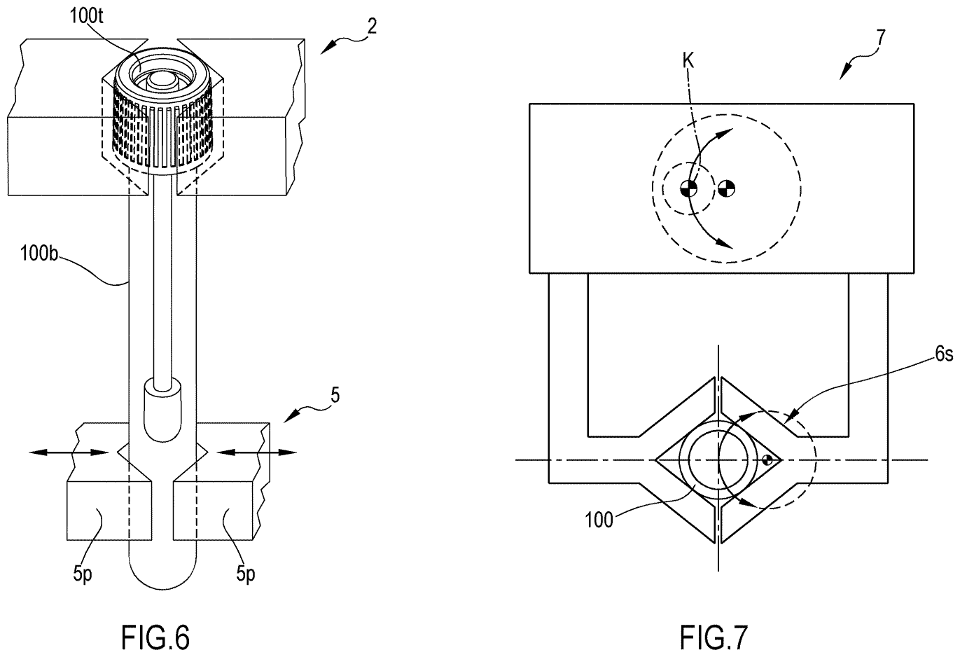

Alternatively with respect to the above, and as shown in FIG. 6, the support 2 can be a support specifically configured for directly engaging with the stopper 100t of the primary container 100. In a non-limiting embodiment, the support 2 can be provided with a two-claws gripper as above described and/or be provided with a portion suitable for housing the stopper 100t by friction coupling.

In an embodiment, the support 2 is configured for housing at least the primary container 100 in a substantially vertical direction, aligned along an axis K substantially vertical and perpendicular to the main support plane 1p.

If present, the hole 2f is arranged at a height lower with respect to the gripper 2p.

The support 2 herein described, although configured for supporting at least one primary container 100, can also housing a secondary container, that will be better described below, in particular where the secondary container is of a shape substantially similar to the one of the primary container 100. This technical function is in particular allowed by the gripper 2p that is capable of adapting to different shapes and/or sizes of part of the retained container.

### Secondary Container

The secondary container 102, 103, 104 can first of all be an open type container or a re-closable type container.

In an embodiment, the secondary container 102 can be an opened container provided with a plurality of cells arranged according to a predefined spatial pattern, in particular arranged in a checkerboard pattern on rows and columns between them orthogonal. Each cell of the plurality of cells is isolated by means of lateral walls from adjacent cells. Consequently, the cells are each one distinguished by a respective opening that is positioned in correspondence of the upper portion thereof. The cells are destined to house each one part of the volume V of sample collected by the sample collection unit 3.

The cells have a substantially vertical development and detect a transversal section of area so as to house at least one tapered ending part of a tip 3p of the sample collection unit 3. This allows to transfer a predetermined amount of sample with the tapered ending part of the tip 3p introduced inside the cell, and reduces the risk of splashing on adjacent cells.

The cells of the secondary container 102 have a first depth lower with respect to cells of a secondary container 103, always of opened type, whose cells are significantly deeper. The technical characteristics of the secondary container 103 are similar to those of the secondary container 102, to whose description we refer.

The secondary container 104 can be a re-closable type container, and be preferably in shape of test tube, then distinguished by an elongated body of substantially cylindrical shape and with axial development. This specific embodiment of the secondary container 104 can have technical characteristics similar to those of the primary container 100 and therefore herein not repeated.

The secondary container or support can be destined to contain samples of biological or microbiological material destined to be subjected to analysis for the presence of HPV, or blood, or plasma, or proteins or pathogens of the respiratory, genital, urinary and/or gastrointestinal tracts.

### Handling Unit

As schematically represented in FIG. 5, the device 1 comprises a handling unit 5, configured for opening and/or closing the stopper 100t of said primary container 100.

The support 2 and the handling unit 5 cooperate together in order to selectively and alternatively engage the body 100b of the primary container 100 and the stopper 100t of the primary container 100 in order to determine the opening and/or the closing of the stopper 100t.

Although in the following portion of description reference will be made to a handling unit 5 particularly destined to directly engage the stopper 100t in order to determine the opening and/or the closing, this should not be interpreted in a limiting way. As it has been already described in the previous portion of description, the support 2 can in fact be a specific support for the stopper 100t of the primary container 100, and in this case would be the handling unit 5 to directly act on said body 100b of the primary container 100 for determining the above-mentioned opening and/or closing.

The data processing unit 4 is configured for determining the activation, in a substantially automated way, of said handling unit 5, before the activation of the sample collection unit 3.

The handling unit 5 is configured and specifically destined to open and/or close stoppers of different size and/or shape. Thanks to this technical characteristic the device 1 object of the present disclosure is particularly of flexible use since it can handle in a substantially automated way primary containers 100 from different manufacturers and/or destined to different applications.

In particular, the handling unit 5 is configured and specifically destined to adapt in a substantially automated way at least at the opening and/or closing of:
at least one first stopper 100t of a first primary container 100, and
at least one second stopper 100t of a second primary container 100,
   wherein the first and the second primary container 100 differ, in particular in correspondence of said first and respectively second stopper 100t, for type and/or shape and/or size.

When the stopper 100t of the primary container 100 must be unscrewed, the data processing unit 4 is configured for determining the activation, in a substantially automated way, of the handling unit 5, before the activation of the sample collection unit 3, as the removal of part of the sample therein contained must be performed with the stopper removed.

Otherwise in other situations the data processing unit 4 can be configured for determining in a substantially automatic way the activation of the handling unit 5 in substantial temporal simultaneity with the activation and/or the control in movement of the sample collection unit 3. This is in particular the case wherein a primary container 100 is placed in the loading station 9 while different rates of the volume V of sample collected from the sample collection unit 3 are distributed in more secondary containers or supports.

The data processing unit 4 controls the handling unit 5 in order that it is carried out the opening of the stopper 100t when the primary container 100 is in said collecting position 3a.

In a non-limiting embodiment, the collecting position 3a corresponds to the position wherein the primary container 100 is housed in the support 2.

Said handling unit 5 is configured for separating the stopper 100t from said body 100b when the primary container 100 is in the collecting position 3a and is preferably configured for opening the stopper 100t by means of a simultaneous rototranslation movement (useful for unscrewing a screwed stopper). More generally, the handling unit 5 is with at least one between a movement of rotation and translation and preferably by means of a combined and simultaneous movement of rototranslation.

For allowing to properly grasp stoppers of different size and/or shape, the handling unit 5 comprises at least one gripper 5p configured for contacting a surface, preferably outer, of said stopper 100t and for retaining said surface at least during the opening and the separation of the stopper 100t from the body 100b preventing a relative rotation of the stopper 100t and/or preventing a relative translation between said stopper 100t and said gripper 5p. The gripper 5p in particular comprises two opposed claws that move radially with respect to a central position between at least one distanced position with respect to said stopper 100t and a contact position with said stopper 100t.

In the distanced position, the two opposed claws are at a distance greater with respect to the distance to which they are when in contact with the stopper 100t.

In a non-limiting embodiment, the claws have an internally concave profile that detects at an angular point.

A rotation motor 5m of the handling unit is installed in correspondence of the gripper 5p and is configured for allowing the rotation thereof around a rotation axis W substantially parallel to the axis Z, and therefore orthogonal to the main support plane 1p in such a way that the claws of the gripper 5p rotate equally spaced to each other with respect to said rotation axis W.

In use, the data processing unit 4 controls the handling unit 5 for moving the gripper 5p, and in particular its opposed claws, between said distanced position and said contact position when the gripper 5p is radially aligned (at the same height) with the stopper 100t.

The translation of the gripper 5p along the rotation axis occurs by means of free movement or forced movement.

In an alternative embodiment, the handling unit 5 is configured for moving the gripper 5p, when in contact position with the stopper 100t, only along an axial direction, preferably substantially vertical. This solution is implementable where the stopper 100t can be disconnected from the body 100b by means of the vertical direction traction only.

In order to allow freedom of movement of the containers on the main support plane 1p and in order to allow design freedom of the spatial configuration of the various stations of the device 1 herein described, in a non-limiting but preferred embodiment the handling unit 5 is arranged in an upper part of the working volume B, and is in particular arranged at a height higher with respect to the height at which it is positioned the main support plane 1p and the support 2. The handling unit 5 is joined to the support frame but is “hanging” and protrudes within the working volume from above.

The handling unit 5 can comprise at least one electronic sensor configured for detecting the presence of a primary container 100 on the gripper 5p. In particular this electronic sensor can be a force sensor. In a preferred but non-limiting embodiment, if the electronic sensor detects the absence of a primary container 100 in an operating condition wherein—on the contrary—this primary container 100 should be lifted and retained from the gripper 5p, this electronic sensor, will send an alarm signal, preferably a stop signal, towards the data processing unit 4 for determining the activation of a visual and/or audio alarm, and/or for determining the stop—preferably instantaneous—of the movement of the primary and/or secondary containers and/or of any additional units present on the device 1.

It is noted that in a particular and non-limiting embodiment, the handling unit 5 can be configured for manipulating at least one primary container 100 already unplugged, for example by a user or by a machine outer with respect to the device herein described.

### The Sample Collection Unit

The sample collection unit 3 comprises a sample collection element, indicated in reference figures with the reference 3p.

Preferably, the sample collection unit 3 is a pipetting unit that comprises a pump of sucking and/or pushing, configured at least for sucking a predetermined volume V of sample, for example from the primary container 100. The sample collection unit 3 is further configured for allowing di retaining this volume V of sample, preferably when sucked by a sample collection element 3p in form of a hollow tip. The retaining of the predetermined volume V of sample occurs for a time sufficient to allow the transfer of the above-mentioned volume V of sample on one or more secondary containers as herein described.

In an embodiment, the volume V of sample is retained within a sample collection element 3p having the shape of a tip. The tip 3p is removably connected to a relative support of the sample collection unit 3. The tip 3p, of substantially cylindrical shape and that is hollow for being operatively connected with the pump of sucking and/or pushing, preferably has a tapered ending portion and suitable for contacting in use the sample and/or for being introduced within at least one between the primary container 100 and the secondary container 102, 103, 104.

In a preferred but non-limiting embodiment, the tip 3p is realized in plastic material and is of disposable type (disposable). The use of disposable tips allows to avoid the contamination of different samples collected in the operating cycle of the device 1.

It is noted that where the tip, or more generally the collection element are not of disposable type, can be provided a washing station, possibly configured for washing and sterilizing this sample collection element 3p.

The release of at least part of the volume V of sample retained is carried out for example by means of the opening of a valve positioned upwards of the tip 3p or by means of an inversion of the sense of rotation of the pump of the sample collection unit 3.

The above described herein controls are carried out in an automated manner under the control of the data processing unit 4.

In order to allow freedom of movement of containers on the main support plane 1p and in order to allow design freedom of the spatial configuration of the various stations of the device 1 herein described, in a non-limiting but preferred embodiment the sample collection unit 3 is arranged in an upper part of the working volume B, and is in particular arranged at a height higher with respect to the height at which it is positioned the main support plane 1p and the support 2. The sample collection unit 3 is joined to the support frame but is “hanging” and protrudes within the working volume from above.

The sample collection unit 3 is configured and specifically destined to allow the tip 3p to make a movement at least of translation on a plane parallel to the main support plane 1p and to make a movement of translation along a direction substantially inclined, preferably substantially orthogonal, to the translation direction along the plane parallel to the main support plane 1p. Then, the preferred embodiment of the sample collection unit 3 presents possibility of triaxial movement (biaxial on the plane, and along a vertical direction, orthogonal to the above-mentioned plane). Optionally, the unit herein described can be configured in such a way as to allow to vary a tilt of the tip 3p with respect to the vertical direction.

The mobility along a vertical axis for the sample collection element, whatever its specific shape, ensures that it is possible to adapt the functionality of the sample collection unit 3 to containers of different depths and/or to different amounts of substances contained within the container.

The sample collection unit 3 is configured for releasing at least part of the volume V of the sample in secondary containers or supports 102, 103, 104 of heterogeneous type. In other words the sample collection unit 3 is configured for releasing at least part of the volume V of the sample in at least:
a first secondary container or support 102, 103, 104 of a first type and/or shape and/or size;
a second secondary container or support 102, 103, 104 of a second type and/or shape and/or size.

Therefore a first part of the volume V of the sample collected from the collection element is released in the first secondary container or support 102, 103, 104 and the second part of the volume V of the sample collected from the collection element is released in the second secondary container or support 102, 103, 104. The second part of the volume V is a residual part, difference between the total volume V collected from the collection element and said first part.

In order to give a high degree of operational flexibility in the handling of containers and/or samples and/or use applications, preferably the sample collection unit 3 is movable between said collecting position 3a and/or said first releasing position 3b and a second releasing position 3b′.

In said first releasing position 3b, the sample collection unit 3 releases a first rate of the volume V of said sample in a first secondary container or support 102; in said second releasing position 3b′ said sample collection unit 3 releases a second rate of the volume V of said sample in at least one second secondary container or support 103, 104. The data processing unit 4 is configured for moving, in a substantially automated way, the sample collection unit 3 from the collecting position 3a to the first releasing position 3b and, subsequently, from the first releasing position 3b to the second releasing position 3b′.

Getting into the detail of technical operation, in use the sample collection unit 3 is configured for:
positioning the support for the tip in correspondence of a magazine (described below) or in correspondence of a collection point of a tip 3p;
subsequently, collecting a tip 3p and fixing it to its support;
moving the tip 3p in said collecting position 3a;
carrying out a collection of the volume V of the sample contained in said primary container 100;
transferring by means of an at least axial or biaxial movement of the tip 3p from the collecting position 3p towards the at least one releasing position 3b, 3b′;
carrying out a release of the at least part of the volume V in said at least one secondary container or support 102, 103, 104 and if appropriate in different secondary containers or supports 102, 103, 104;
subsequently, positioning the tip 3p in a releasing position of the tip, and
actuating or allowing the actuation of a disconnection of the tip 3p from the relative support.

Without considering it in a limiting way, at least two between said collecting position 3a, said first releasing position 3b and said second releasing position 3b′ are arranged at a same height.

In the preceding described sequence by means of list points, is present a step of transfer by means of at least an axial or biaxial movement of the tip 3p from the collecting position 3p towards the at least one releasing position 3b, 3b′. In the herein described step, the data processing unit 4 is configured for determining, in a substantially automated way, a control in movement of the sample collection unit 3 from the collecting position 3a to the first releasing position 3b by means of a composite movement comprising:
a raising of the height from a first lower height to a second higher height,
a translation along a plane, when at a height different with respect to said first lower height, in particular when at said second higher height;
a new lowering to said second lower height.

The lower heights are the one related to the collecting position 3a and to the at least one releasing position 3b, 3b′. The second higher height is the translation height along a plane substantially parallel to the main support plane 1p.

Alternatively or in combination with the above described the sample collection unit 3 can comprise a sample collection element 3p in shape of collection loop and/or cylinder and/or little spoon and/or ring, it too preferably of disposable type (disposable) and therefore removably connectable to the support already described.

In this case the pump of sucking and/or pushing may not be necessary. The device di collection of samples 3p can be advantageously configured for retaining a predetermined volume V of sample for surface tension, or for gravity.

In a particular embodiment, the sample collection unit 3 can be provided with the pump and be also provided with a support configured for housing a sample collection element 3p of different type, and be therefore a sample collection unit of hybrid type.

Where the sample collection unit 3 is a pipetting unit, the pump of said unit 3 is a pump configured for sucking a determined volume of sample by creating a vacuum inside the tip that, in use immersed in the sample, sucks in said determined volume.

In an embodiment, the pump can be a piston pump, then with a linear actuator translating with reciprocating movement for carrying out the sucking of the determined volume of sample within the, or the pushing of at least part of said volume of sample outside the, tip. The adjustment of the sucked or pushed volume is primarily determined from the control of the movement (linear translation) carried out by the piston inside its cylinder. The longer is the translation, the greater is the sucked or pushed volume. In this case the sample collection unit 3 is configured for determining the volume V of sample sucked or transferred inside or outside the tip on the basis of a movement of the actuator of the pump (piston) in a direct way.

Alternatively, the sample collection unit 3 can be configured for determining a volume V of sample sucked or pushed in an indirect way. In this case the sample collection unit 3 can, as in the preceding case, be provided with a pump for creating a vacuum inside the tip, but the stopping of the pump does not determine (directly, as a causal effect) the sucked volume but, on the contrary, is determined (indirectly then) by a control signal produced by a volume sensor.

The volume sensor can be positioned on the tip or, alternatively, be installed directly and immovably, on the sample collection unit 3. Preferably, but non-limiting thereto, the volume sensor is a capacitive sensor.

The volume sensor is then configured for measuring the volume V of sample that progressively fills the tip or that empties out from the tip, and for sending a corresponding control signal to the pump that ends an interruption of the sucking or pushing cycle thereof when this control signal corresponds to the desired determined volume V of sample.

### Compartments Below the Main Working Plane

As it is schematically represented in FIGS. 1 and 2, compartments closed by doors extend under the main working plane 1p. In particular a main compartment houses a container 3c configured for housing sample collection elements 3p of the sample collection unit 3, when removed.

The sample collection elements 3p are in use made to fall into a hopper or duct 3k that allows the access from a portion of the device 1 above the main working plane 1 to the compartment below the main working plane 1p. This compartment is indicated in FIG. 2 with the reference 3u. The position wherein is present the hopper or duct 3k detects the releasing position of sample collection elements 3p described in the previous paragraph.

In a preferred and non-limiting embodiment, the duct 3k allows the fall of the sample collection element 3p along a significantly vertical direction. The container 3c is removable.

A device for the removal of the tip 3p is activated in an automatic way by the data processing unit 4 of the device 1 following the completion of the release cycle of the sample in the first and, if that is the case, in the second releasing position 3b, 3b′.

The assembly formed by the container 3c and from the duct or hopper 3k realizes a disposal unit for sample collection elements 3p, which-for typical intended use of the device 1 object of the present disclosure, may be biohazard elements, infected with pathogens of viral, bacterial, fungal type, etc.

### Magazine of the Sample Collection Unit

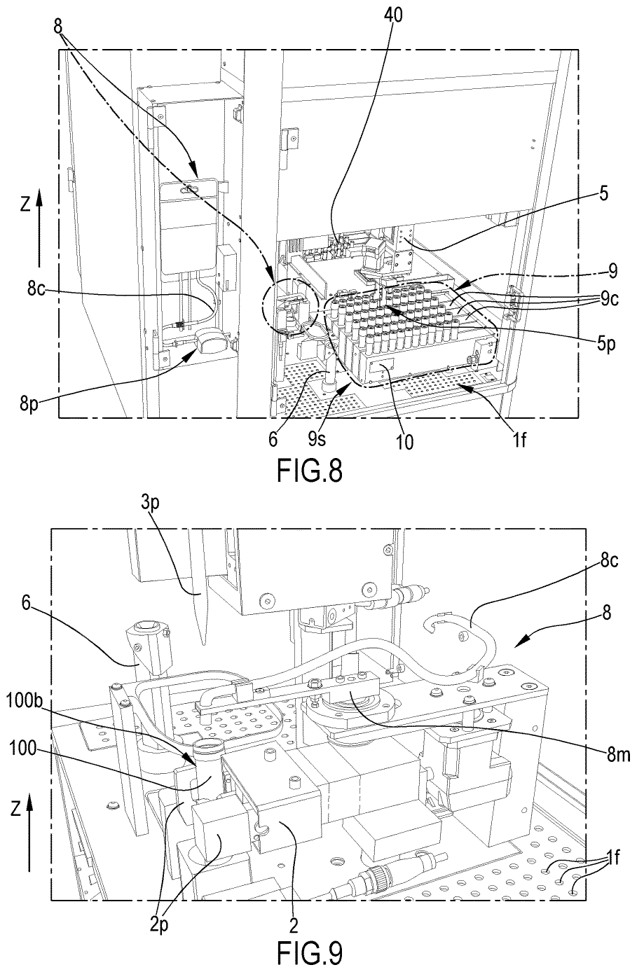

As represented in FIG. 8, the device 1 object of the present disclosure comprises a magazine 40 for the sample collection unit 3, which is configured for containing a plurality of sample collection elements 3p, preferably arranged and ordered in a specific spatial configuration.

The sample collection unit 3 is operatively associated to said magazine and in use is controlled by the data processing unit 4 in order to collect a sample collection element 3p from the above-mentioned magazine.

Therefore, positioning the support in correspondence of the magazine 40, as above described, comprises positioning the support in correspondence of a predefined area of said magazine and extracting from the above-mentioned area a sample collection element 3p.

The data processing unit 4 stores the position (relative or absolute) of each sample collection element 3p contained in the magazine and associates to each position in the magazine an identification flag of the presence or absence of the sample collection element 3p. If the magazine is completely full, the identification flags are all of a same value (for example “1”).

The collection of a first sample collection element 3p that is necessary for collecting the volume V of sample from the primary container 100 implies an extraction from a first position in the magazine of a first sample collection element 3p. The identification flag of the first position is changed in value by the data processing unit 4 (for example, brought to “0”).

After the disconnection of the sample collection element 3p from the support and after the collection of it in the container 3c, another collection of a new sample collection element 3p from a second position in the magazine can occur. The data processing unit 4 excludes the possibility of a new collection of a sample collection element 3p from a same first position of the magazine.

The collection of a second sample collection element 3p that is necessary for collecting the volume V of sample from the primary container 100 implies an extraction from a second position in the magazine of a first sample collection element 3p. The identification flag of the second position is changed in value by the data processing unit 4 (for example, brought to “0”). The process gradually repeats itself.

### Unit for Agitation or Centrifugation

In a preferred but non-limiting embodiment, the device 1 object of the present disclosure comprises at least one centrifugation unit 6. The centrifugation unit 6 is configured for allowing the centrifugation of at least one primary container 100 or of the secondary container or support 102, 103, 104, pushing by centrifugal force a part of the sample within a predefined portion (bottom portion) of the at least one primary container 100 or of the secondary container or support 102, 103, 104.

As it is schematically represented in FIG. 5, in a non-limiting embodiment, the centrifugation unit 6 comprises an oscillating eyelet 6t fixed on a support placed at a determined height with respect to the main support plane 1p. The height is defined at the project stage in relation to at least one size of the container. Preferably this height is equal at least to the maximum size of the container that the eyelet 6t is destined to support, or is at least equal to the extension of the portion of container that in use shall be extended between the eyelet 6t and the main support plane 1p for allowing the centrifugation.

In use, in the eyelet 6t is introduced the primary container 100 or the secondary container or support 102, 103, 104, especially when in shape of test tube. In particular in FIG. 5 is represented a configuration wherein the axis of the eyelet 6t (axis W) is significantly inclined with respect to a vertical direction E. This configuration is typically the one wherein the eyelet 6t is when placed in rotation around a sensibly vertical axis vertical.

The eyelet defines a central axis and can be actuated in rotation in a procedure automatically controlled by the data processing unit 4.

As a result of the actuation in rotation, that occurs along a substantially vertical axis, the axis of this eyelet that, when the primary container 100 or the secondary container or support 102, 103, 104 is herein introduced, coincides with the axis of the primary container 100, by effect of the centrifugal force moves from a sensibly vertical direction to an inclined direction with respect to the vertical axis that allows to push by centrifugal force a part of the sample within a predefined portion (bottom portion) of the at least one primary container 100 or of the secondary container or support 102, 103, 104.

Alternatively to the above, in an embodiment that is not shown in the attached figures, the centrifugation unit 6 can comprise a carousel with non-tilting seats, destined each one to retain a container or support in correspondence of a predefined portion.

Alternatively or in combination with the centrifugation unit 6, the device 1 object of the present disclosure can present an agitation unit 7. The agitation unit 7 is configured for allowing the agitation of the at least one primary container 100 or of the secondary container or support 102, 103, 104.

In particular, the agitation unit 7 is configured for agitating the sample contained in said primary container 100 or in said secondary container or support 102, 103, 104 moving said primary container 100 on a movement of rotation eccentric with respect to a reference axis K (vortexing).

This reference axis K is preferably substantially vertical, then orthogonal to the main support plane 1p.

The data processing unit 4 is configured for activating said centrifugation unit 6 and/or said agitation unit 7 in a predefined temporal sequence with respect to the activation of the sample collection unit 3: in detail the activation sequence is such that the activation of the centrifugation unit 6 and/or of the agitation unit 7 occurs before the activation of said sample collection unit 3. The sequencing of activations and/or movements of the units herein described occurs according to an automatic procedure, stored in the data processing unit 4.

FIG. 7 shows a non-limiting embodiment of an agitation unit 7 configured for operating on a primary 100 or secondary 102 container in form of a test tube.

As schematically represented in FIG. 4, in an embodiment the agitation unit 7 is arranged in substantial correspondence of the support 2. In particular the support 2 is installed in fixed position on a movable portion of the agitation unit 7, and is destined to be placed in rotation describing a circular movement with respect to the rotation axis K substantially vertical. The support 2, in shape of a ring, retains the primary container 100 (in FIG. 4 in shape of test tube) along a direction parallel to the axis K. This configuration results therefore particularly compact.

Alternatively, the agitation unit 7 can be a unit separated with respect to the support 2 and be in particular a unit provided with an its own auxiliary support 6s. This configuration is instead represented in FIG. 7. The auxiliary support comprises a movable gripper between a first distanced position with respect to the primary 100 or secondary 102 container and a second position in contact with said primary 100 or secondary 102 container. Also in this case the agitation unit 7 comprises a movable portion of the agitation unit 7, and is destined to be placed in rotation describing a circular movement with respect to the rotation axis K substantially vertical.

The data processing unit 4 controls the rotation speed of the movable portion of the agitation unit 7 and/or controls the agitation time of the primary container 100.

The data processing unit 4 controls the activation of said centrifugation unit 6 and/or said agitation unit 7 in a predefined temporal sequence with respect to the activation of said sample collection unit 3.

In a preferred but non-limiting embodiment, when the device 1 herein described is in the condition of operating with a primary container 100, the data processing unit 4 activates said centrifugation unit 6 and/or said agitation unit 7 before the activation of said sample collection unit 3.

Otherwise, in particular where there is interest in working with a secondary container or support 102, preferably in shape of test tube, the data processing unit 4 activates said centrifugation unit 6 and/or said agitation unit 7 following the activation of said sample collection unit 3.

Also alternatively, the centrifugation unit 6 can be positioned in substantial correspondence of the support 2 (i.e., the support 2 can provide for the characteristics of the centrifugation unit previously described).

The handling unit 5 is configured for carrying out in an automatic way a step of movement of said at least one primary container 100 between the support 2 and the centrifugation unit 6, in particular the secondary support 6s, by means of a predefined movement, preferably composite of rotation, of translation or of rototranslation and carries out this step retaining the primary container 100 in correspondence of the stopper 100t. Although in principle it can be considered that the handling unit 5 can keep the primary container 100 in correspondence of a portion different with respect to the stopper 100t, the solution of retaining on the stopper 100t advantageously allows to keep unchanged the gripping position during the various movements of the primary container 100, simplifies the operation of the device 1 and ensures therefore a higher safety of handling the above-mentioned container and an easier programming of the data processing unit 4.

The device 1 object of the present disclosure is configured for carrying out, if necessary, the centrifugation of the at least one primary container 100 before the eventual action of collection of part of the sample herein contained from the sample collection unit 3. Then, the activation of the handling unit 5 for moving the at least one primary container 100 between the support 2 and the centrifugation unit 6 occurs in a predefined temporal sequence with respect to the activation of said sample collection unit 3, and in particular occurs before the activation of the sample collection unit 3.

### The Filling Unit

The device 1 herein described is preferably configured for allowing a partial filling of at least one between said primary container 100 and said secondary container or support 102, 103, 104 by means of, preferably, a filling or dilution fluid.

For this purpose, the device 1 comprises at least one main filling unit 8, comprising at least one duct 8c of feeding of at least a substance, preferably fluid, preferably within the at least one between said at least one primary container 100 and said secondary container or support 102, 103, 104.

As schematically shown in FIG. 2, the filling unit 8 presents a tank for said substance that is replaceable and that is arranged in a lateral compartment of the device 1 preferably accessible by means of a door.

The at least one filling unit 8 comprises a pump 8p, optionally an occlusive pump, operatively connected to the duct 8c.

The purpose of the filling unit 8 is to carry out a rehydration and/or dilution of the, and/or an addition of a lysing substance or anyway reagent to, the sample contained in said at least one between said at least one primary container 100 and said secondary container or support 102, 103, 104; in this regard, the Applicant notes in fact that the sample could be a dry sample, and for being properly subjected to subsequent analyses should be preventively rehydrated with an adequate volume of for example a rehydrating, diluent, listing substance or however reagent.

Thanks to this technical characteristic it is possible to make the device 1 specifically configured for allowing to operate on containers that contain dry samples, that before the analysis of chemical, biological or microbiological nature need to be properly rehydrated, or on containers that contain samples that, although not dry, still need to be diluted and/or lysed or anyway made to react with a substance reagent.

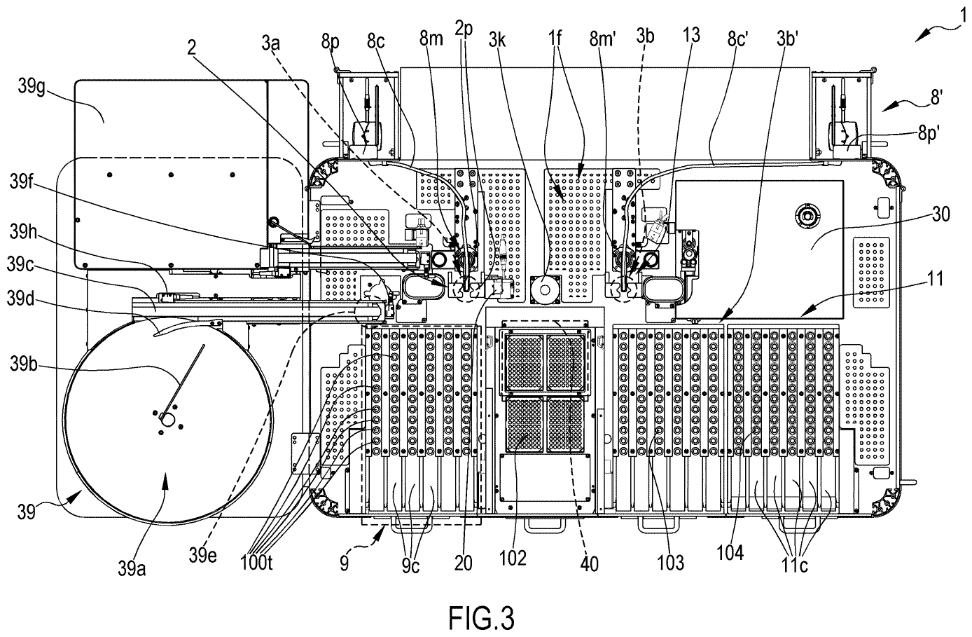

Reference is made to the FIGS. 3, 9 and 10. With particular reference to hydration or dilution of samples contained in a primary container, in a non-limiting embodiment, the filling unit 8 is configured for adding a controlled volume of said at least a substance in the at least one primary container 100 when said primary container 100 is in correspondence of the support 2, in particular when it is housed on the support 2. Said controlled volume is variable, and the filling unit 8 is configured in such a way as to be able to deliver, at each delivery cycle, quantities of volume varying from container to container. In particular, a sequential delivery of a first controlled volume of substance in a first container and of a second controlled volume of substance in a second container can be such that the first volume is different from the second volume.

In the specific embodiment represented in the attached figures, the duct 8c is a duct realized in plastic and/or rubber material and is therefore flexible and compressible.

The occlusive pump, that in particular is a peristaltic pump, acts in use on the duct 8c compressing it, determining said feeding of the controlled volume of said at least a substance within said at least one between the at least one primary container 100 and the secondary container or support 102, 103, 104. The use of an occlusive pump, allows to control the delivering volume with great precision.

Since the opening of the container, both primary 100 and secondary 102, 103, 104 is facing upward, in order not to interfere with the interaction of the handling unit 5 and of the sample collection unit 3, the Applicant has conceived a particular and non-limiting embodiment of the filling unit 8 comprising a movable actuator 8m, connected to a predefined portion, preferably an ending portion, of said duct 8c.

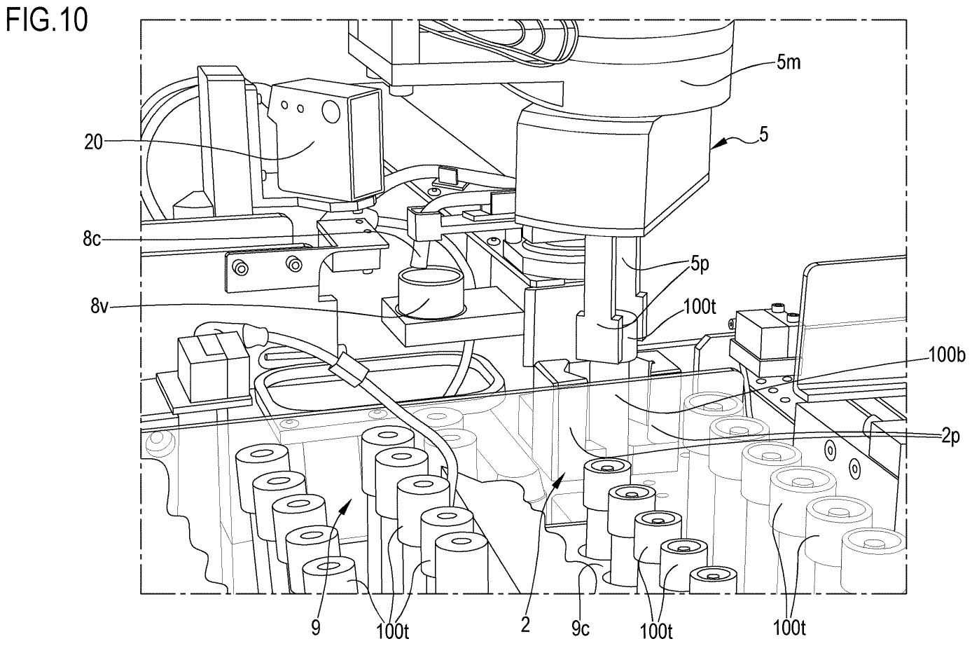

The movable actuator 8m is configured for being moved, by means of the control of the data processing unit 4, at least between:
a first operating position wherein said ending portion of said duct 8c is substantially aligned to an opening of the primary container 100 and/or of the secondary container or support 102, 103, 104 (refer to FIG. 9),
a second operating position wherein the ending portion of said duct 8c is misaligned to the opening of said primary container 100 and/or of the secondary container or support 102, 103, 104 (refer to FIG. 10).

A sequential delivery of a substance in two different containers occurs as follows: displacement of the movable actuator 8m from the first operating position (wherein occurs the first addition of substance to the container) to the second operating position, and at least one new displacement of the movable actuator 8m from the second operating position towards the first operating position.

The data processing unit 4 can be configured for determining, by means of the filling unit 8, a substantial restriction of the duct 8c when the movable actuator 8m is arranged in a position different with respect to said first position, and in particular when it is in said second position. In a non-limiting embodiment, the above-mentioned restriction occurs preferably by means of a stop of the pump when of peristaltic type.

In a preferred but non-limiting embodiment, the movement between said first operating position and said second operating position occurs by means of a rotation around a predefined axis, preferably substantially vertical and i.e. on a plane parallel to the main support plane 1p. Preferably, but non-limiting thereto, the rotation of the movable actuator 8m is controlled by means of a stepper electric motor controlled by the data processing unit 4. The feeding of the at least a previously mentioned substance takes place as follows. The data processing unit 4 is configured for:
keeping deactivated the pump 8p when said movable actuator 8m is in the second operating position;
activating said pump 8p when said movable actuator 8m is in said first operating position;
keeping activated said pump 8p for a time sufficient to supply a predefined volume of the at least a substance;
deactivating the pump 8p before the movement of the movable actuator 8m from the first operating position to the second operating position.

A recovery tank 8v is provided in correspondence of the second operating position. This allows to collect part of the substance that should possibly still come out downstream of the deactivation of the pump 8p and after the movement of the movable actuator 8m towards the second position.

The fact that in the present disclosure reference has been made to “at least one filling unit” implies that the device 1 can have a first and at least one second filling unit 8′, the characteristics thereof are preferably the ones of the previously described filling unit and therefore not repeated.

The first and the second filling unit are configured for being controlled by the data processing unit 4 independently and can operate on different containers and/or supports, for example operating:
the first filling unit 8 on at least one primary container 100;
the second filling unit 8′ on one or more secondary containers 102, 103, 104.

The first and the second filling unit can be activated in substantial temporal simultaneity and/or at different time instants.

If the first filling unit 8 is configured for operating on a primary container 100 arranged in correspondence of the support 2, the second filling unit 8′ is configured for operating on a secondary container arranged in a position different with respect to the position of the support 2, for example in correspondence of a or more releasing stations that are better described below.

In a non-limiting embodiment, the tank 8k, 8k′ is substantially floppy and/or deformable; preferably, the tank is a bag—of the type similar to the one commonly used for plasma and/or blood.

Alternatively, the tank 8k, 8k′ can be a bottle, then a container substantially rigid that typically is realized in glassy or plastic material.

The duct 8c comprises an ending, opposed with respect to the one where the delivery occurs, that is connected to said tank, in particular to said bag, in a removable way.

In a non-limiting embodiment, the tank presents a collection portion and the duct 8c is connected in correspondence of said collection portion.

Preferably, in use the collection portion of the tank, in particular of said bag, is in a portion substantially low, preferably in a bottom portion. This facilitates a complete emptying of the tank.

In use, by action of the pump 8p, as the substance is transferred from the tank and by means of the duct 8c towards one or more secondary containers or supports, the tank, if of floppy type, it is gradually deformed by effect of the progressive emptying. If the tank is rigid, this deformation does not exist, and can be provided a valve or an air inlet for compensating the inner pressure of the tank as a result of its progressive emptying.

From the structural point of view, the device 1 object of the present disclosure comprises a compartment suitable for containing the bag, that is hung so as to have the collecting position in said bottom portion.

Preferably, but non-limiting thereto, the collection portion comprises a self-sealing container, that isolates again the tank, in particular the bag, when the duct 8c is disconnected from the tank itself.

The Applicant has conceived a particular embodiment, wherein the filling unit 8 is configured and specifically destined to add said at least a substance, simultaneously, in a plurality of primary containers 100, or in a plurality of secondary containers or supports 102, 103, 104, or in at least one first primary container 100 and in at least one first secondary container or support 102, 103, 104. In this case, clearly, in the first operating position the ending portion of the duct 8c, that is clearly at least provided with a first and second outlet, is substantially aligned in such a way that:
the first outlet and the second outlet are aligned respectively to a first and a second primary container 100;
the first outlet is aligned to a primary container 100 and the second outlet is aligned to a secondary container or support 102, 103, 104 or vice versa;
the first and the second outlet are aligned respectively to a first and a second secondary container or support 102, 103, 104.

The above-mentioned alignment occurs in correspondence of the upper opening of each container or support and is then a substantially vertical alignment.

The Applicant has conceived a particular embodiment of the device 1 herein described that comprises:
at least one support 2 configured for retaining at least one between a primary container 100 and a secondary container or support 102, 103, 104 in a predefined position;
at least a sample collection unit 3, movable between at least:
   a collecting position 3a, wherein the sample collection unit 3 collects at least part of the sample contained in the primary container 100, and retains a volume V of the sample; and
   a first releasing position 3b, wherein the sample collection unit 3 releases at least part of the volume V of the sample in at least one secondary container or support 102, 103, 104;
wherein the device 1 comprises a data processing unit 4 configured at least for determining the execution, in a substantially automated way, di:
   a control in movement of the sample collection unit 3 between the collecting position 3a and said at least one first releasing position 3b, and
   an activation of the sample collection unit 3 for carrying out:
      a collection of the volume V of the sample contained in said primary container 100, and
   a release of the at least part of the volume V in said at least one secondary container or support 102, 103, 104;
wherein the device 1 comprises at least one filling unit 8, comprising at least one duct 8c of feeding of at least a substance, preferably fluid, within said at least one between said at least one primary container 100 and said secondary container or support 102, 103, 104;
preferably wherein the filling unit comprises at least one tank removably connected to the duct 8c, wherein the tank is preferably substantially floppy and/or compressible, and is preferably configured for deforming after a progressive emptying from the substance, and/or wherein the filling unit 8 is configured and specifically destined to add the at least a substance, simultaneously, in a plurality of primary containers 100 or in a plurality of secondary containers or supports 102, 103, 104 or in at least one first primary container 100 and in at least one first secondary container or support 102, 103, 104.

FIG. 3 shows a specific embodiment of the device 1 object of the present disclosure wherein are present a first filling unit 8 and a second filling unit 8′. The structural details of the second filling unit 8′ are not described in detail, since the components, in particular the tank 8k′, the pump 8p′, the duct 8c′ and the movable actuator 8m′, of the second filling unit 8′ are preferably identical to the ones of the first filling unit 8.

The first and the second filling unit 8, 8′ are independent from each other, and can be activated in a simultaneous way or in an alternative way by the data processing unit 4.

In particular, the second filling unit 8′ can advantageously operate with secondary containers or supports 102, 103, 104 moved by means of the conveying unit 12 the operation of which is described with greater detail in the following portions of the description.

### Loading Station

As schematically represented in FIG. 2 and, for example, in FIG. 3, the device 1 herein described comprises at least one first loading station 9 configured for housing a plurality of primary containers 100.

The data processing unit 4 controls the automated movement of the handling unit 5 for moving at least one primary container 100 from said loading station 9 to said support 2.

The movement occurs by means of a predefined movement, preferably composite of rotation, of translation or of rototranslation and in particular comprises:
a translation between a first and a second height, in particular a raising of at least one primary container 100 from a first and lower height to a second and higher height;
a translation on a plane substantially parallel to the main support plane 1p up to a position corresponding to the vertical on the support 2;
a further translation between the second height and the first height, in particular a lowering of at least one primary container 100 from the second and higher height to the first and lower height.

From the structural point of view, the loading station 9 comprises at least one slide 9s configured for housing removably at least one magazine 9c having a plurality of seats for said primary containers 100.

In a preferred but non-limiting embodiment, each seat houses a respective primary container 100.

Preferably further, the seats of each magazine are all of the same type and/or shape, and are then configured for housing a univocal type and/or shape and/or size of primary container 100. This technical characteristic allows to consider at the operational level that each container that may be contained on the magazine 9c is of a same type and/or shape and/or size.

Different magazines can house primary containers 100 of different type and/or shape and/or size.

In the attached figures is shown a particular embodiment of device 1 wherein the loading station 9 comprises a plurality of slides 9s configured for housing removably a respective plurality of said magazines 9c. The plurality of slides 9s allows the independent introduction and/or extraction of a respective magazine 9c. In this way the user can for example introduce a first magazine 9c with primary containers 100 having a first diameter and/or length and a second magazine 9c, in a second time, with primary containers 100 having a second diameter and/or length.

As it is clearly visible in the attached figures the slides 9s are arranged along directions parallel to each other and are arranged on a same plane, in particular on the main support plane 1p; is anyway predictable that the slides can be arranged on distinct planes, for example in such a way that a slide is placed at a first height and a second slide is placed at a second height, where the first height is higher than the second height. It is also predictable that the directions of alignment of a first slide 9s and of a second slide 9s are inclined to each other.

The operational flexibility is therefore optimized as:
the producer, can produce a device 1 that can be sold to users that use, each one, primary containers 100 of different type and/or shape and/or size;
the user can substantially use the same device 1 with almost no structural alterations, with primary containers 100 of different type and/or shape and/or size.

Although this should not be intended in a limiting way, the slides 9s preferably extend along a substantially axial direction and, coherently, the magazines 9c extend along a same axial direction. Each magazine 9c preferably houses the respective seats aligned along a predefined direction of alignment coinciding with the axial direction of extension, and the seats are placed at a predefined, and constant, distance from each other. This technical characteristic facilitates the scheduling of the sequential extraction of primary containers 100 by the of the handling unit 5.

In use, the data processing unit 4 is configured for actuating in movement the handling unit 5 for collecting in sequential way a first primary container 100 and a second primary container 100 from a respective first and second seat of a magazine 9c.

The data processing unit 4 electronically detects, preferably by means of the electronic identification tag 9z described hereinafter, or has stored the location (distance) between two contiguous seats of a magazine 9c, and/or has stored the absolute position of at least two contiguous seats of a magazine 9c.

The data processing unit 4 configures the handling unit 5 for:
moving the handling unit 5 in correspondence of the first seat of the magazine 9c;
extracting from the first seat of the magazine 9c at least one first primary container 100;
conveying from the first seat of the magazine 9c said at least one first primary container 100 towards the support 2;
   and, subsequently at the activation of the sample collection unit 3:
collecting said at least one first primary container 100 from the support 2, and then
moving in correspondence of the first seat of the magazine 9c, and
depositing said at least one first primary container 100 in said first seat of the magazine 9c.

Subsequently the data processing unit 4 configures the handling unit 5 for:
displacing the handling unit 5 from the first seat to the second seat of the magazine 9c;
extracting from the second seat of the magazine 9c at least one second primary container 100;
conveying from the second seat of the magazine 9c said at least one second primary container 100 towards the support 2;
   and, subsequently at the activation of the sample collection unit 3:
collecting from the support 2 said at least one second primary container 100, and then
moving in correspondence of the second seat of the magazine 9c, and
depositing said at least one second primary container 100 in said second seat of the magazine 9c.

A further loading station is indicated in FIG. 3 with the numerical reference 39. This further loading station can be present together with the loading station indicated with the numerical reference 9, or be present as a replacement of the latter. For the purposes of the present disclosure, the further loading station 39 is described as a second loading station. The loading station indicated with the numerical reference 9 is then a first loading station. As visible in FIG. 3, the second loading station 39 comprises at least one magazine 39a in shape of carousel, preferably but non-limiting thereto leaning on the main support plane 1p or on a plane substantially parallel to the main support plane 1p. On the magazine 39a is in use arranged a plurality of primary containers 100, preferably with flat bottom and/or of substantially squat shape. The magazine 39a houses within it, and/or is joined to, at least one singularizer or separator 39b.

In the magazine a carousel the primary containers 100 are preferably arranged in a loose manner. There are no seats suitable for housing the containers in predefined positions.

The magazine 39a comprises a substantially planar bottom surface and a lateral wall extending along a substantially oblique direction, preferably orthogonal, with respect to the planar wall.

The second loading unit 39 also comprises a conveyor 39c destined to move at least one primary container 100 from a first starting position in proximity of the magazine 39a to a second arrival position indicated with the numerical reference 39e.

The conveyor 39c is preferably destined to house a primary container 100 leaning on it, and lies therefore under the primary container 100. In an alternative embodiment, the conveyor 39c can be destined to convey a hung primary container 100.

In an embodiment the singularizer or separator 39b comprises a movable blade in rotation around a substantially vertical axis, in particular describing a circular movement destined to cause a transfer of a primary container 100 at a time on the conveyor 39c.

A portion of the lateral wall of the magazine 39c presents an opening delimited by an indented portion 39d of said lateral wall, the radially more inner part thereof is next to the distal portion of the singularizer or separator 39b. The distal portion is the radially outer one, more remote with respect to the rotation axis of the singularizer or separator 39b.

In a non-limiting embodiment, the conveyor 39c is a conveyor belt and extends along a substantially linear path.

In correspondence of the first starting position, which is next to the opening of the lateral wall of the magazine 39a, is present a first sensor 39h suitable for detecting the presence of a primary container 100. When a primary container 100 is detected from the first sensor 39h, an activation signal is transmitted from the first sensor 39h towards an actuator of the conveyor 39c, that is then moved for displacing the primary container 100 from the first starting position to the second arrival position 39e.

A second sensor 39f is placed in substantial correspondence of the second arrival position 39e, i.e. in proximity of an ending portion of the conveyor 39c. The second sensor 39f is configured for detecting the presence of a primary container 100 in proximity; in use, when a primary container 100 is detected from the second sensor 39f, a deactivation signal is transmitted from the second sensor 39f towards an actuator of the conveyor 39c, that is then stopped for allowing that the primary container 100 is kept in said second arrival position 39e.

Preferably, the first sensor 39h and the second sensor 39f are of a same type. In a non-limiting embodiment, they are optical sensors.

In a different configuration, in the second loading station 39 can be present a single sensor 39h configured for allowing to identify the presence of a primary container 100 when in said first starting position and in said second arrival position. The sensor 39h can be in this case a rotating sensor or carried in translation between a first operating position in proximity of said first starting position and a second operating position in proximity of said second arrival position.

The second arrival position 39e can be a position from which the handling unit 5 collects the primary container 100 for transferring it in correspondence of the support 2, or can alternatively be a position that detects a support 2, and in correspondence of which the handling unit carries out the removal of the stopper 100t in the previously described modes.

A storage area is indicated by the numerical reference 39g. The storage area 39 of the second loading station 39 is configured and specifically destined to house a plurality of primary containers 100 downwards of the handling carried out by the handling unit 5. The data processing unit 4 can be configured for determining the activation of the handling unit 5 in such a way that the primary container 100, starting from the second arrival position 39e, or from the support 2, is moved towards the storage area 39g.

Where the device 1 object of the present disclosure is provided with a first loading station 9 and of a second loading station 39 as above described, the data processing unit 4 can be programmed so as to cause an activation of the handling unit 5 for moving a first primary container 100 from said first loading station 9 and, subsequently for moving a second primary container 100 from said second loading station 39; it appears then clear that the handling unit 5 can be configured for manipulating, in particular for moving and/or for opening and/or closing the stopper 100t of a first and a second primary container 100 located in a first and a loading station 9, 39 placed in different positions of the device 1 and containing, preferably, each one primary containers 100 of different type and/or shape and/or size (for example, narrower and in shape of test tube, with substantially rounded bottom housed in the first loading station 9 and wider, a shape of smaller jar and with flat bottom in the second loading station 39) with no need of manual adaptation by the user.

### Electronic Identification of the Magazines And/or of Containers

Optionally, but preferably, the device 1 object of the present disclosure is configured for allowing an electronic identification of the magazines and/or of the containers herein present. This allows also in an almost automatic way, by means of the data processing unit 4, the specific function of the device 1 according to the typology of magazine and/or of container installed on the loading station.

For example, by means of this electronic identification, the data processing unit can be configured for activating the filling unit 8 only in case of operation (handling) carried out on a first type of primary containers 100 and for not activating the filling unit 8, and then for avoiding of diluting and/or re-hydrating or lysing or make the sample react, in case of operation (handling) carried out on a second type of primary containers 100.

As schematically represented in FIG. 13, in a non-limiting embodiment, each magazine of said plurality of magazines 9c comprises an electronic identification tag 9z.

The loading station 9 comprises a reader 9r for the electronic identification tag 9z.

The electronic identification of said at least one magazine 9c occurs by means of a reading of electronic data stored in said electronic identification tag 9z.

In a preferred embodiment this electronic identification tag 9z is a wireless tag, in particular a RFID tag. Consequently the reader 9r is a reader specifically configured for reading wireless tag, in particular RFID tag.

The RFID tag 9z comprises first of all a memory that is configured for storing electronic data, an antenna and a physical support, typically realized in plastic material, that integrates the memory and, if it is the case, the antenna.

Preferably the memory is a non-volatile type memory, for example and non-limiting thereto a EEPROM or FRAM memory.

In an embodiment, the RFID tag can be of active, passive, semi-active or semi-passive type.

A RFID tag of passive type is configured for replying with a transmission of a determined wireless signal only when queried by a reader that transmits a predefined query signal. In this case, the power of the signal received by the RFID tag is sufficient to generate enough power to transmit a reply signal. Such a passive device is without a battery.

A RFID tag is also able to be written by a transmitter device; in this case a wireless signal is transmitted toward the RFID tag 9z and the data carried by means of the above-mentioned signal are stored in the memory of the device.

A RFID tag of active type is typically provided with an internal powering battery, and further than the memory typical also of the RFID tag, has optionally several antennas for receiving and/or transmitting and/or storing signals on multiple wireless channels. The range of the transmission of the RFID tag of active type, is greater with respect to the range of the transmission of the RFID tag of passive type.

A RFID tag of semi-passive type is provided too with a memory and a battery, but the battery is used only to power a microchip, if present, or auxiliary apparatuses; the battery is not used to power the transmission of the signal provided as a reply to a query signal. In other words, upon query, a RFID tag of semi-passive type behaves in a way in principle identical to a RFID tag of passive type.

A RFID tag of semi-active type is provided too with a memory and a battery, but in this case the battery is destined also to supply power for the transmission of the reply signal to the query signal. Usually, the RFID tag is deactivated and is powered only upon reception of a predefined transmission signal, operating in a way similar to a RFID tag of passive type.

The RFID tag is capable of operating, in principle, on a wide variety of frequency ranges-from LF to frequencies in the microwave range.

It is herein below proposed a non-limiting example of frequency bands that can be used for RFID tag:
125/134 kHz (LF)
13.56 MHz (HF)
433 MHz (UHF, typically used for active tags)
860-960 MHz (UHF)
2.4 GHz (UHF, typically used for active or passive tags)
5.8 GHz (SHF, generally used only for active tags).

The Applicant notes that the RFID tag that operate in LF (125/134 kHz) and HF (13.56 MHz) bands are provided for in the ISO standards as passive.

In an embodiment, the RFID tag can be, or can be made to operate, in read only mode. The read only mode is a mode in which the data contained in the memory of the RFID tag can only be read and not written.

In an alternative embodiment, the RFID tag can be, or can be made to operate, in read/write mode. The read/write mode is such that at least part of the data contained in the memory of the RFID tag can be both written and read.

In a particular embodiment, the RFID tag can comprise a memory wherein:
a first part of the memory can be written and/or read;
a second part of the memory can be only read.

In an embodiment, the data that can be stored in the memory are for example tracking data of said sample and/or of the device 1 and/or of analysis method of said sample and/or of collection date of said sample, and/or of transport conditions of said sample.

The data that can be stored in the memory can also include a univocal identification code of the RFID tag. This code can be attributed by the producer of the RFID tag or by the producer of the device 1 herein described. This code is stored in such a way that it cannot be altered; in an embodiment wherein are present the first part of the memory and the second part of the memory, this univocal identification code is stored in the second part of the memory.

The presence of a univocal identification code allows to safely track the device herein described; the possibilities of alteration, especially unintentional, of the univocal identification code only electronically readable are almost negligible.

The RFID tag can be configured for transmitting a wireless electronic signal that includes or not said univocal identification code. In particular, there can be the following configurations:
at each query the RFID tag transmits only the univocal identification code in the reply signal;
at each query the RFID tag transmits in the reply signal at least part of the data of the memory, preferably of the first part of the memory, that do not include said univocal identification code;
according to the query signal, the RFID tag transmits:
   a) only the univocal identification code; or
   b) transmits at least part of the data of the memory, preferably of the first part of the memory, that do not include said univocal identification code; or
   c) transmits at least part of the data of the memory, preferably of the first part of the memory, that do not include said univocal identification code and the univocal identification code.

In the case of item c), the transmission of the univocal identification code can:
follow, temporally, the transmission of at least part of the data of the memory, preferably of the first part of the memory, that do not include said univocal identification code and the univocal identification code, or alternatively
precede, temporally, the transmission of at least part of the data of the memory, preferably of the first part of the memory, that do not include said univocal identification code.

In a non-limiting embodiment, the data processing unit 4 is configured for activating the reading of the RFID tag before the activation of the handling unit 5, and/or before the activation of the sample collection unit 3 and/or before the activation of the agitation 7 and/or centrifugation 6 unit and/or before the filling unit 8. This allows to appropriately configure the operation of the device 1 according to the specific type of primary container 100 that the device 1 is having to manipulate downstream of the introduction of the magazine 9c in the respective guide of the loading station 9.

### Releasing Station

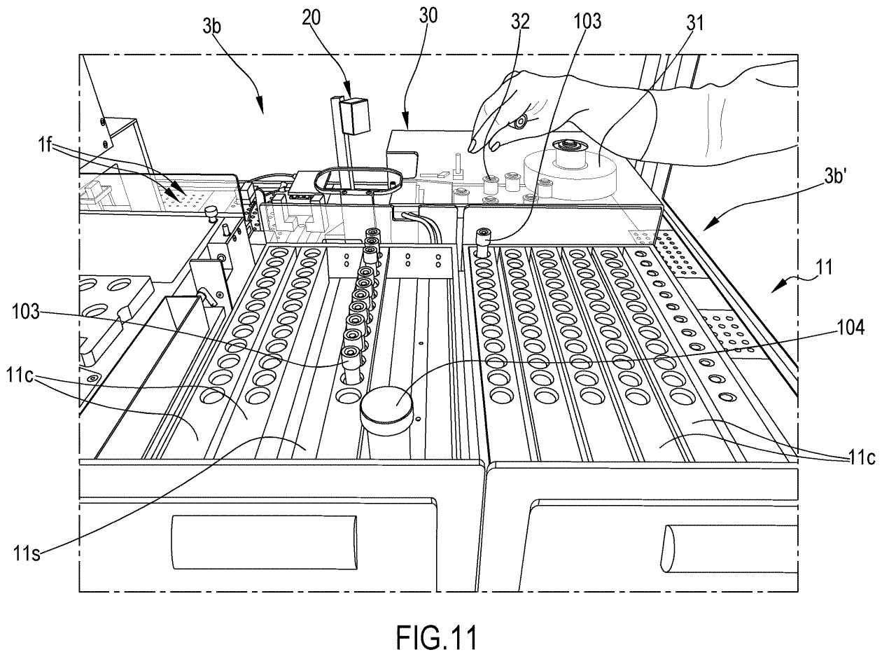

As schematically shown in FIG. 11, the device 1 object of the present disclosure comprises preferably at least one releasing station 11 configured for housing a plurality of secondary containers 102, 103, 104.

The specific embodiment shown in the attached figures presents a plurality of releasing stations 11. The at least one releasing station 11, or the plurality of them, if present, is configured for housing secondary containers 102, 103, 104 of different shape and/or size.

In a non-limiting embodiment, the first releasing position 3b is arranged, optionally the first releasing position and the second releasing position 3b′ are arranged, in correspondence of said at least one releasing station 11. Alternatively, the device 1 comprises an auxiliary support 13 for at least one secondary container 104, in particular for a secondary container in shape of test tube. In this case, the auxiliary support 13 is arranged in a position different with respect to the releasing station 11 and the first releasing position 3b is arranged in correspondence of said auxiliary support 13.

According to the specific configuration, the data processing unit 4 controls in movement in a substantially automatic way the handling unit 5 for moving at least one secondary container 102, 103, 104 from the auxiliary support 13 to the releasing station 11 and/or for moving the primary container 100 from the support 2 to the releasing station 11. Preferably but non-limiting thereto, the movement occurs by means of a movement composite of rotation, of translation or of rototranslation.

The Applicant has conceived a specific embodiment of the device 1 wherein the movement of at least one secondary container 102, 103, 104 from the auxiliary support 13 to the releasing station 11 and/or the movement of the at least one primary container 100 from the support 2 to the releasing station 11 occurs by means of a conveying unit 12 that is distinct from the handling unit 5 and that is further independently movable with respect to the handling unit.

It shall be intended that the conveying unit 12 can be activated and put in movement also simultaneously to the handling unit 5. The data processing unit 4 is then capable of actuating an automatic control procedure wherein the handling unit 5 and the conveying unit 12 are simultaneously activated for conveying respectively a distinct first and a second container, that can be at least one between a primary container 100 and a secondary container or support 102, 103, 104.

The simultaneity of activation and of movement between the two preceding units should not be intended in a limiting way as implying that the start and stop of the activation and of the movement of the two units should occur at a same time instant: it is sufficient that there is at least one minimum time lapse wherein the two above-mentioned units are activated in a simultaneous way for ensuring the above-mentioned “simultaneity”.

The releasing station 11, similarly to the configuration structure of the loading station 9, comprises at least one slide 11s configured for housing removably at least one magazine 11c.

The magazine has a plurality of seats for said secondary containers 102, 103, 104, and preferably each seat is configured for housing a respective secondary container or support 102, 103, 104.

The embodiment of the device 1 shown in the attached figures presents a releasing station 11 that comprises a plurality of slides 11s configured for housing removably a respective plurality of said magazines 11c.

The plurality of slides 11s allows the independent introduction and/or extraction of a respective magazine 11c. Thanks to this technical characteristic a user can eventually extract a magazine 11c from a respective slide 11s, in particular when completely loaded with secondary containers by the handling unit 5 or by the conveying unit 12, without necessarily interrupting the operation of the device 1.

Slides 11s preferably extend along a substantially axial direction, and, coherently, the magazines 11c extend along a same axial direction. Each magazine 11c preferably houses the respective seats aligned along a predefined direction of alignment coinciding with the axial direction of extension, and the seats are placed at a predefined, and constant, distance from each other. This technical characteristic facilitates the programming of the handling unit 5 or of the conveying unit 12 in the positioning sequence of a plurality of secondary containers or supports on the respective slide.

The data processing unit 4 is configured for automatically activating said handling unit 5 and/or the conveying unit 12 so that, in use, is carried out a movement of at least one secondary container or support 102, 103, 104 from the auxiliary support to the releasing station 11 and for moving the primary container 100 from the support 2 to the releasing station 11 after the control in movement of the sample collection unit 3 from the collecting position 3a to the first releasing position 3b and, where present, from the first releasing position 3b to the second releasing position 3b′.

### Fracturation Unit

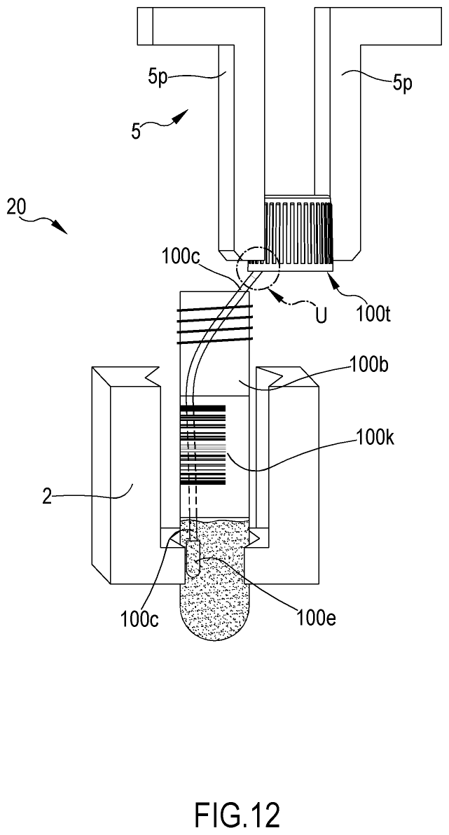

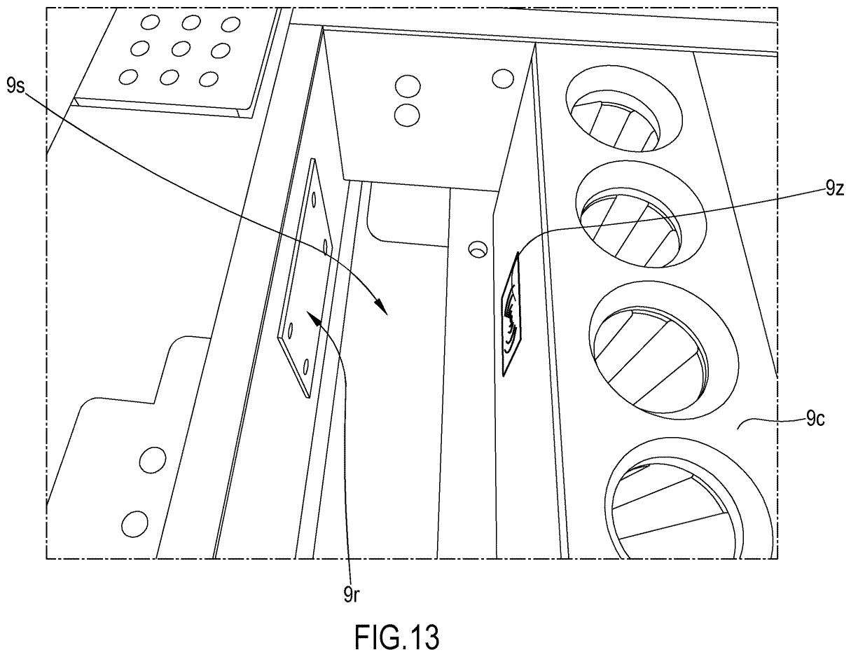

In the preceding portion of description has been mentioned that an embodiment of the primary container 100 presents a swab 100c whose elongated body 100d that extends between the stopper 100t and the collecting portion 100e of the swab itself can be fractured. A specific embodiment of fracturation unit is represented in FIG. 12.

The fracturation occurs in an automatic way by means of a fracturation unit of the device 1. This technical characteristic in addition to allowing an advanced and complex handling of the primary container 100, reduces the risk of user contamination and reduces the risk of swapping the pair swab 100c-primary container 100 that otherwise would be possible in case of handling manually carried out by a user.

In an embodiment, the device 1 herein described comprises a fracturation unit that is destined to allow the fracture of the elongated body 100d in an intermediate portion between the portion joined to the stopper 100t and the collecting portion 100e.

The fracturation unit is configured and specifically destined to grasp the stopper 100t and a moving the stopper 100t relatively to the body 100b of the primary container 100 and is also destined to cause the fracturation of the elongated body 100d in said predefined intermediate portion.

In an embodiment the fracturation unit presents of the cutting means in use acting on the elongated body 100d in order to fracture it in said predefined portion (indicated in FIG. 12 with the reference sign U). In this embodiment, the fracturation unit keeps the elongated body 100c in a position substantially not in contact with the body of the primary container 100.

In another embodiment, the fracturation unit is configured for moving, preferably translating, the stopper 100t with respect to the body 100b of the primary container 100 first by bringing the elongated body 100c in contact with an inner surface of the body 100b and deforming the elongated body 100c until causing its fracture, making it fall and/or keeping the collecting portion 100e within the body 100b. Alternatively or in combination with the fracturation unit can be configured for rotating the stopper 100t with respect to the body 100b and can also be configured for rototranslating the stopper 100t with respect to the body 100b in order to obtain the fracture.

FIG. 12 shows a particular configuration wherein the fracturation unit is flexing significantly the elongated body 100c, that is not yet fractured, but that will soon be fractured in correspondence of the predefined portion U. Although in an embodiment of the device 1 object of the present disclosure the fracturation unit can be a stand-alone unit, in a preferred embodiment the fracturation unit coincides with the handling unit 5.

The handling unit 5 carries out then not only the opening and/or closing of the stopper 100t, and the physical separation of the stopper 100t from the body 100b of at least one primary container 100, ma-preferably-carries out also the fracturation of the elongated body 100c in the above-described mode.

Preferably, the fracturation occurs when the primary container 100 is arranged and retained on the support 2, and then in a time instant after the transport from the magazine 9c to the support 2.

### Reading Unit

In a preferred embodiment, the device 1 object of the present disclosure presents a reading unit 20 configured for reading the tag 100k present on the primary container 100. The reading unit 20 comprises an optical reader that is configured for carrying out an automatic remote reading, i.e. without the need of contact with the primary container 100 or with its tag 100k.

Preferably, but non-limiting thereto, the data processing unit 4 controls the activation of the reading unit 20 for causing a reading of the tag 100k when the at least one primary container 100 is retained by the handling unit 5 in the previously described modes.

In a preferred embodiment, although not limiting, the activation of the sample collection unit 3 occurs after the reading of the tag 100k present on the primary container 100. It is predictable that the absence of a tag 100k or the reading of a code that, when electronically processed, results to be wrong, can determine-always by means of the data processing unit 4-at least one between a stopping of the device 1 or the sending of a sound and/or visual alarm.

In a non-limiting embodiment, the code present on the tag 100k, when read and appropriately recognized, can determine for example the variation of the volume V of sample collected from the primary container 100.

### Tagging Unit

Optionally the device 1 object of the present disclosure comprises a tagging unit 30 that is configured and specifically destined to apply a tag on at least one between a primary container 100 and a secondary container or support 102, 103, 104. The tagging unit is controlled by the data processing unit 4.

As schematically represented in FIG. 3, preferably, the tag is a self-adhesive tag, and the tagging unit 30 comprises a printer electronically connected with the data processing unit 4; the printer is configured for printing alphanumeric and/or visual codes (bar codes, or QR codes or similar) on the tag before applying on the at least one between a primary container 100 and a secondary container or support 102, 103, 104.

The tagging unit 30 comprises at least one magazine 31 for tags, in particular for virgin tags, not yet submitted to the printing process by means of the printer of the tagging unit 30. Tags are herein arranged on a belt on which are arranged in sequence, preferably in a single row. Tags are gradually collected, preferably one at a time, from the above-mentioned belt as they are applied on said at least one between a primary container 100 and a secondary container or support 102, 103, 104.

The tagging unit 30 is preferably configured for applying a tag on said at least one between a primary container 100 and a secondary container or support 102, 103, 104 with a rotatory movement occurring between a tool and the above-mentioned at least one between a primary container 100 and a secondary container or support 102, 103, 104. In a preferred embodiment, the tool is kept substantially still while said at least one between a primary container 100 and a secondary container or support 102, 103, 104 is made to rotate around a substantially vertical axis, then substantially orthogonal with respect to the main support plane 1p. Rollers 32 are present in the tagging unit 30 for guiding the belt of tags until in proximity of the at least one between a primary container 100 and a secondary container or support 102, 103, 104 and/or for pushing and making the tag well adhere on the body of the container or support.

The at least one between a primary container 100 and a secondary container or support 102, 103, 104 is positioned in correspondence of the tagging unit 30 from one between the handling unit 5 and the conveying unit 12.

In use, therefore the tagging unit 30 first prints the data on a virgin tag and subsequently applies the printed tag on the container or support. The printing is preferably a thermal printing.

The tagging unit 30 is operatively connected with the data processing unit 4 for receiving from this latter electronic data that lead to the printing of the tag.

In a non-limiting embodiment, the device 1 object of the present disclosure is configured for printing a tag 100k on a secondary container or support 102, 103, 104 by means of the tagging unit 30 in such a way that the data printed on the tag by the tagging unit 30 correspond to the data present on a tag present on primary container 100. In this way it is advantageously possible to trace and logically pair the sample of the secondary container or support 102, 103, 104 with the one possibly still present in the primary container 100.

In a specific embodiment, the device 1, in particular by means of the data processing unit 4, configures the tagging unit 30 such as that, for a plurality of tags printed on a respective plurality of secondary containers or supports 102, 103, 104, at least a first part of the data present on said tags is retrievable, and then common, on the plurality of tags. This first part of the data is preferably also retrievable on the tag of the primary support 100.

Assume the case wherein a sample present in a primary support 100 should be subdivided, preferably in equal parts, on a first, a second, a third secondary container or support 102, 103, 104, and that that it is intended to keep a traceability and a logical coupling between the sample of the primary container 100 with the samples of the three secondary containers or supports 102, 103, 104. In this case, the first part of the data is for example an alphanumeric code (or a visual code traceable to said alphanumeric code) that allows to let intend that the sample contained in the first, second and third secondary container or support 102, 103, 104, is the same sample originally present in a determined primary container 100. A second part of data printed on the tags of each of the three secondary containers or supports 102, 103, 104, allows for example to distinguish in a univocal way the secondary container or support 102, 103, 104.

For example, if the first part of data comprises the following alphanumeric code A12345(identifier of the specific primary container 100 da cui is collected the sample), the second part of data will be, for example _01 for the first secondary container or support, _02 for the second secondary container or support and _03 for the third secondary container or support, so that the tag data of the first, of the second and of the third secondary container or support respectively are A12345_01, A12345_02 and A12345_03. This functionality is particularly useful where the different rates of sample collected from the primary container and arranged in the three secondary containers or supports 102, 103, 104 should each one be subjected to a specific chemical analysis, or added by a specific reagent. The tagging that the device 1 is capable of carrying out is therefore of dynamic type.

The data, in particular both the first part of data and the second part of data, are stored in a memory (database) electronically accessible to the data processing unit 4 so that they can be received at a subsequent time after the tagging.

The Applicant has specified different operating configurations of the device 1 wherein, when the tagging unit 30 works on secondary containers or supports, the tagging occurs on one or more secondary containers or supports 102, 103, 104 still empty, wherein the collection unit 3 has not yet transferred at least one part of the volume V of the sample of the primary container 100 or, alternatively, occurs on one or more secondary containers or supports 102, 103, 104 already partially filled with part of the volume V of sample collected by the collection unit 3 from the primary container 100.

The retrieval of the code, or also only of a code portion, on the tag 100 of the primary container 100, so that it is possible to subsequently proceed with the printing of the at least a tag 100k for one or more secondary containers or supports 102, 103, 104, is carried out by means of the reading unit 20 previously described. Clearly this reading unit 20 is then activated by the data processing unit 4, in an automated way, before the tagging.

Although it is herein explicitly described a tagging unit 30 configured for printing originally virgin tags, it is possible that the tagging unit 30 is configured for applying pre-printed tags, and is therefore without printer.

In a preferred embodiment the tagging unit 30 can be configured and specifically controlled for carrying out a post-tagging control of the primary container 100 and/or of the secondary container or support 102, 103, 104. In a preferred but non-limiting embodiment, the tagging unit 30 comprises at least one device reader that, when appropriately controlled by the data processing unit 4, automatically an optical reading procedure of the recently applied tag 100k, in order to verify for example its presence, or the presence of the code, or the correct rotation (spatial arrangement in relation to the body or to the stopper of the container or support).

In an embodiment, an electronic signal of consent is sent from the device reader, by means of the tagging unit 30, towards the data processing unit 4 only when the tag has been correctly applied, and in order that the handling unit 5 or the conveying unit 12 transport the at least one between the primary container 100 and the at least one secondary container or support 102, 103, 104, only in case of consent transmitted from the device reader.

Also it is possible to configure the data processing unit 4 for carrying out a coherence control, for example by verifying an identity between the code present on the tag of the secondary container or support 102, 103, 104 with the code present on the tag of the corresponding primary container 100, or between the first part of the code present on the tag of the secondary container or support 102, 103, 104 with the code, or at least part of the code, present on the tag of the primary container or support 100.

In a non-limiting embodiment, the tagging unit can be configured for managing at least one first tag format and a second tag format. These first and second format can in particular differ between them according to at least one of the following parameters: shape (for example, one square, the other rectangular or circular), size, material, thickness, color, stiffness, level of self-adhesiveness. Also, tags having the first format can be virgin whereas tags having the second format can be pre-printed.

The tagging unit can be programmed by means of the data processing unit 4 for selecting alternatively the delivery of tags having the first format or the second format, or can alternatively be configured for acknowledging in an automatic way the tag format to be applied.

In an embodiment, the tagging unit can be provided with a magazine of tags specifically configured for housing a plurality of tags according to the first format and, simultaneously, a plurality of tags according to the second format. In use, the tagging unit 30, by means of actuators specifically destined for the purpose, selects one between a tag having the first format or, alternatively, the second format on the basis of electronic data transmitted to it by means of the data processing unit 4, and deriving from the primary container 100, or from its tag or from the RFID tag of the magazines, or from the type of secondary containers or supports. Preferably this occurs without, or with a minimum, manual control by the user. After the selection, can occur the printing process as above described.

### Details of the Data Processing Unit

The data processing unit can comprise a general-purpose type processor, or one or more application-specific integrated circuits (ASIC), and/or an FPGA and/or a programmable logic controller (PLC) for the control of the various servo actuators present on the device 1. Such servo actuators, where not specifically described are to be intended as standard type. Such servo actuators can be with electrical control and/or with control of hydraulic and/or pneumatic and/or magnetic type.

On the data processing unit can be executed a computer program that comprises portions of software code that, when executed by the data processing unit, causes the actuation of the various components herein described according to the specific configurations and/or sequences of movement described in the present document.

It is further intended that the data processing unit should not be considered as a single physical entity, but can comprise different components physically arranged in different areas of the device 1, that all together cooperate for allowing the operation of the device 1 in the herein described modes. Likewise, it should not be intended in a limiting way that the data processing unit is physically installed within the device 1, being in fact possible to have the data processing unit at least partly placed outside the device 1.

The invention is not limited to the embodiments shown in the attached figures; for this reason, reference signs indicated in the claims are provided for the sole purpose of increasing the intelligibility of the claims and are not limiting.

It is then clear that to the object of the present disclosure can be applied additions, modifications or variants obvious for an expert in the art without exiting from the scope of the attached claims.

1. A device for the collection and the handling of samples, preferably biological, microbiological or chemical samples, from a primary container, the device comprising:
at least one support configured for retaining at least one between a primary container and/or a secondary container or support in a predefined position,
at least one sample collection unit, movable between at least:
a collecting position wherein said sample collection unit collects at least part of the sample contained in said primary container, and retains a volume of said sample; and
a first releasing position wherein said sample collection unit releases at least part of the volume of said sample in at least one secondary container or support;
wherein the device comprises a data processing unit configured at least for determining the execution, in a substantially automated way, of:
a control in movement of the sample collection unit between said collecting position and said at least one first releasing position, and
an activation of the sample collection unit for carrying out:
a collection of the volume of the sample contained in said primary container, and
a release of the at least part of said volume in said at least one secondary container or support;
the device further comprising a handling unit, configured at least for opening and/or closing a stopper of said primary container configured for being removably coupled to a body of said primary container;
and wherein the handling unit is configured and specifically destined to open and/or close primary containers having stoppers and/or bodies of different size and/or shape.

2. The device according to claim 1,
wherein the assembly formed by the support and by the handling unit is configured and specifically destined to adapt in a substantially automated way at least at the opening and/or closing of:
at least one first stopper of a first primary container, and
at least one second stopper of a second primary container;
wherein the first and the second primary container differ in correspondence of said first and respectively second stopper, for type and/or shape and/or size or wherein the first and the second primary container differ in correspondence of said body for type and/or shape and/or size;
particularly wherein the handling unit is configured and specifically destined to adapt in a substantially automated way at least to the opening and/or closing of:
at least one first stopper of a first primary container, and
at least one second stopper of a second primary container;
wherein the handling unit is configured for directly contacting the stopper of said primary container and/or said first stopper of said first primary container and said second stopper of said second primary container;
wherein said data processing unit is configured for determining the activation, in a substantially automated way, of said handling unit, for at least the unscrewing of said stopper, before the activation and/or the control in movement of the sample collection unit or in substantial temporal simultaneity with the activation and/or the control in movement of the sample collection unit;
wherein said handling unit is configured at least for opening said stopper when said primary container is in said collecting position,
preferably wherein said handling unit is configured for separating said stopper from said body in said collecting position and/or wherein said handling unit is configured for opening said stopper by means of at least one between a movement of rotation and translation and preferably by means of a combined and simultaneous movement of rototranslation.

3. The device according to claim 1, wherein the sample collection unit is configured for releasing at least part of the volume of said sample collected in secondary containers or supports of heterogeneous type, and/or wherein the sample collection unit is movable between said collecting position and/or said first releasing position and a second releasing position and wherein:
in said first releasing position said sample collection unit releases at least a first part of the volume of said sample collected in a first secondary container or support;
in said second releasing position said sample collection unit releases at least a second part of the volume of said sample collected in at least a second secondary container or support;
preferably wherein the data processing unit is configured for determining, in a substantially automated way, a control in movement of the sample collection unit from the collecting position to the first releasing position and, subsequently, from the first releasing position to the second releasing position;
optionally wherein said sample collection unit comprises, or is, a pipetting unit and comprises a sample collection element in form of a hollow tip, configured for retaining at least said volume of said sample, said hollow tip being configured for being removably connected to a support for tips of said sample collection unit, and wherein the sample collection unit comprises a pump, operatively connected to said hollow tip and configured for sucking or pushing at least part of said volume of said sample respectively inside or outside of said hollow tip,
wherein the sample collection unit is configured for determining said volume of said sample collected from said primary container or at least partially released in said at least one secondary container or support and/or sucked or pushed respectively inside or outside of said hollow tip in function of a movement of an actuator of said pump,
or wherein at least one between the sample collection unit and/or said hollow tip presents a volume sensor configured for detecting a volume of sample present within said hollow tip and for transmitting a control signal having a value function of said volume of sample present within said hollow tip, and wherein the sample collection unit is configured for determining said volume of said sample collected from said primary container or at least partially released in said at least one secondary container or support and/or sucked or pushed respectively inside or outside of said hollow tip in function of the control signal provided by said volume sensor.

4. The device according to claim 1, comprising at least one between a centrifugation unit and an agitation unit for said at least one primary container and/or said secondary container or support,
and wherein:
said centrifugation unit is configured for centrifugating said primary container pushing by centrifugal force a part of the sample within a predefined portion, optionally a bottom portion, of said at least one primary container and/or of said secondary container or support;
said agitation unit is configured for agitating said sample contained in said primary container and/or said secondary container or support preferably moving said primary container and/or said secondary container or support on a movement of rotation eccentric with respect to a reference axis
said data processing unit being configured for activating said centrifugation unit and/or said agitation unit in a predefined temporal sequence with respect to the activation of said sample collection unit, and optionally for activating said centrifugation unit and/or said agitation unit before the activation of said sample collection unit.

5. The device according to claim 4, wherein at least one between said agitation unit and said centrifugation unit is positioned in substantial correspondence of said support, preferably wherein said centrifugation unit is positioned in substantial correspondence of said support and the centrifugation unit is positioned remotely with respect to said support or lies on a same support plane on which lies or is installed the support, and comprises a secondary support configured for housing and retaining said primary container and/or said secondary container or support during its centrifugation;
said handling unit being configured for moving said at least one primary container between said support and said centrifugation unit, in particular said secondary support by means of a predefined movement, preferably composite of rotation, of translation or of rototranslation;
said handling unit being configured for moving said at least one primary container between said support and said centrifugation unit retaining said at least one primary container in correspondence of a predefined retaining portion, preferably in correspondence of said stopper
said data processing unit being configured for activating said handling unit for moving said at least one primary container between said support and said centrifugation unit in a predefined temporal sequence with respect to the activation of said sample collection unit, and optionally for activating said handling unit for moving said at least one primary container before the activation of said sample collection unit.

6. The device according to claim 1, comprising at least one filling unit, comprising at least one feeding duct of at least one substance, preferably fluid, preferably within said at least one between said at least one primary container and said secondary container or support;
said at least one filling unit being configured for carrying out a rehydration and/or dilution and/or a lysis and/or a reaction of the sample contained in said at least one between said at least one primary container and said secondary container or support;
preferably wherein said at least one filling unit is configured for adding a controlled volume of said at least a substance in said at least one primary container when said primary container is in correspondence of said support and/or in said at least one secondary container or support when said secondary container or support is in correspondence of said support;
said at least one filling unit comprising a pump, optionally an occlusive pump, operatively connected to said duct,
preferably wherein said at least one duct is of flexible and/or compressible type and wherein said occlusive pump acts in use on said duct compressing it, determining said feeding of said controlled volume of said at least a substance within said at least one between said at least one primary container and said secondary container or support;
optionally wherein said filling unit comprises at least one tank connected, preferably removably, to said duct, said tank being substantially floppy and/or compressible, preferably configured for deforming after a progressive emptying from said substance, and/or wherein said at least one filling unit is configured and specifically destined to add said at least a substance, preferably simultaneously, in a plurality of primary containers or in a plurality of secondary containers or supports or in at least one first primary container and in at least one first secondary container or support.

7. The device according to claim 6, wherein said at least one filling unit comprises a movable actuator, connected to a predefined portion, preferably an ending portion, of said duct,
said movable actuator, being configured for being moved at least between:
a first operating position wherein said predefined portion, preferably said ending portion, of said duct substantially aligned to an opening of said at least one primary container and/or of said at least one secondary container or support,
a second operating position wherein said predefined portion, preferably an ending portion, of said duct is misaligned with respect to said opening of said at least one primary container and/or of said secondary container and/or support;
preferably wherein the movement between said first operating position and said second operating position occurs by means of a rotation of said movable actuator around a predefined axis, preferably substantially vertical,
and/or preferably said data processing unit is configured for:
keeping deactivated said pump when said movable actuator is in said second operating position;
activating said pump when said movable actuator is in said first operating position;
and optionally
keeping activated said pump for a time sufficient to supply a predefined volume of the at least a substance;
deactivating the pump before the movement of the movable actuator from the first operating position to the second operating position.

8. The device according to claim 1, comprising at least one first loading station configured for housing a plurality of primary containers and wherein said handling unit is configured for moving at least one primary container from said at least one first loading station to said support by means of a predefined movement, preferably composite of rotation, of translation or of rototranslation;
and wherein said at least one first loading station comprises at least one slide configured for housing removably at least one magazine having a plurality of seats for said primary containers,
said seats being suitable for housing, each one, a respective primary container;
preferably wherein said at least one first loading station comprises a plurality of slides configured for housing removably a respective plurality of said magazines,
said plurality of slides allowing the independent introduction and/or extraction of a respective magazine.

9. The device according to claim 8, wherein said at least one first loading station is configured for allowing the electronic identification of said at least one magazine, preferably for allowing the selective electronic identification of each magazine of said plurality of magazines,
preferably wherein each magazine of said plurality of magazines comprises an electronic identification tag and wherein said at least one first loading station comprises a reader for said electronic identification tag, and wherein the electronic identification of said at least one magazine comprises a reading of electronic data stored in said electronic identification tag.

10. The device according to claim 8, wherein said at least one first loading station comprises:
a conveyor configured for moving a primary container from a first starting position to a second arrival position,
at least one magazine configured for housing a plurality of primary containers and comprising, and/or joined to, at least one singularizer or separator configured for transferring a primary container of said plurality of primary containers from said magazine to said first starting position;
wherein said data processing unit is configured for activating the handling unit for moving at least one primary container from said second arrival position to said support by means of a predefined movement, preferably composite of rotation, of translation or of rototranslation, and for opening and/or closing the stopper of said primary container when the primary container is in correspondence of said support, or wherein said data processing unit is configured for activating the handling unit for opening and/or closing the stopper of said primary container when the primary container is in said second arrival position or for activating the handling unit for transferring the primary container from said second arrival position or from said support to a storage area of said at least one first loading station.

11. The device according to claim 1, comprising at least one releasing station configured for housing a plurality of secondary containers,
said at least one releasing station being configured for housing secondary containers of different shape and/or size;
wherein said first releasing position is arranged, optionally said first releasing position and said second releasing position are arranged, in correspondence of said at least one releasing station,
or wherein said device comprises an auxiliary support for at least one secondary container, said auxiliary support being arranged in a position different with respect to said releasing station and wherein said first releasing position is arranged in correspondence of said auxiliary support,
wherein said handling unit is configured for moving at least one secondary container or support from said auxiliary support to said releasing station and/or for moving said primary container from said support to said releasing station by means of a predefined movement, preferably composite of rotation, of translation or of rototranslation,
and/or wherein said device comprises a conveying unit independently movable with respect to said handling unit and configured for moving at least one secondary container or support from said auxiliary support to said releasing station and/or for moving said at least one primary container from said support to said releasing station.

12. The device according to claim 11, wherein said releasing station comprises at least one slide configured for housing removably at least one magazine having a plurality of seats for said secondary containers,
said seats being suitable for housing, each one, a respective secondary container or support;
preferably wherein said releasing station comprises a plurality of slides configured for housing removably a respective plurality of said magazines,
wherein said plurality of slides allows the independent introduction and/or extraction of a respective magazine.

13. The device according to claim 12, wherein the data processing unit is configured for automatically activating said handling unit and/or said conveying unit for moving at least one secondary container or support from said auxiliary support to said releasing station and/or for moving said primary container from said support to said releasing station after said control in movement of the sample collection unit from the collecting position to the first releasing position and, optionally, from the first releasing position to the second releasing position.

14. The device according to claim 8, wherein said at least one magazine comprises at least one first seat for a first primary container and a second seat for a second primary container
and wherein the data processing unit is configured for determining the activation, in a substantially automated way, of said handling unit, for:
moving the handling unit in correspondence of the first seat of the magazine;
extracting from the first seat of the magazine at least one first primary container;
conveying said at least one first primary container from the first seat of the magazine towards a position different with respect to a position of said first seat, preferably towards said support;
drawing said at least one first primary container from the support;
moving the handling unit in correspondence of the first seat of the magazine;
depositing said at least one first primary container in said first seat of the magazine, and subsequently,
moving the handling unit from the first seat to the second seat of the magazine;
preferably, actuating said control in movement of the sample collection unit after said transport of said at least one first primary container from the first seat of the magazine towards said position different with respect to a position of said first seat.

15. The device according to claim 1, comprising a fracturation unit, configured for fracturing a predetermined portion of an elongated body of a swab joined to the stopper of said primary container;
said fracturation unit being configured for causing a permanence of a collecting portion joined to said elongated body within said primary container after the fracture;
preferably wherein said fracturation unit is configured for moving said stopper with respect to a body of said primary container for causing said fracturation, more preferably wherein said fracturation unit is configured for translating said stopper with respect to said body and determining said fracturation by means of an interference between the elongated body of said swab and said body of the primary container preferably in substantial correspondence of said predetermined portion;
optionally wherein said handling unit acts in quality of said fracturation unit,
preferably wherein the data processing unit is configured for determining the activation of the sample collection unit after said fracturation.

16. The device according to claims claim 1, comprising a tagging unit configured for applying at least one tag on at least one between said at least one primary container and/or a secondary container or support,
wherein the tagging unit comprises a tag applying tool and is configured for applying said tag by means of at least one movement of relative rotation occurring between said at least one between said at least one primary container and/or a secondary container or support and said tag applying tool;
and/or wherein the data processing unit is configured for activating the tagging unit before the activation of said sample collection unit and/or before the control in movement of the sample collection unit such that the tagging of said at least one secondary container or support occurs on at least one secondary container or support empty and/or free from said at least part of said volume released by the sample collection unit, or for activating the tagging unit after the activation of said sample collection unit and/or after the control in movement of the sample collection unit such that the tagging of said at least one secondary container or support occurs on at least one secondary container or support at least partially filled and/or provided with said at least part of said volume released by the sample collection unit.

17. The device according to claim 16, wherein the tagging unit comprises at least one printer, configured for printing at least one code, on said tag,
wherein said code comprises at least a first part, optionally a first part and a second part, said second part being different from said first part, said first part corresponding to a code, or to a corresponding first part of a code, electronically retrieved on a tag of said at least one primary container,
preferably wherein the tagging unit is configured for activating said printer for printing a plurality of tags on a respective plurality of secondary containers or supports in such a way that said plurality of tags contains codes having, each one, a first common part, in particular a first part corresponding to said code or said first part of code electronically retrieved by the tag of said at least one primary container, and having, each one, a second univocal part, different for each secondary container or support of said plurality of secondary containers or supports.

18. A method for the collection and the handling of samples, preferably biological, microbiological or chemical samples, from a primary container, the method comprising:
a positioning of at least one container for samples in correspondence of at least one support configured for retaining at least one between a primary container and/or a secondary container or support in a predefined position;
a movement of a sample collection unit between at least:
a collecting position wherein said sample collection unit collects at least part of the sample contained in said primary container, and retains a volume of said sample; and
a first releasing position wherein said sample collection unit releases at least part of the volume of said sample in at least one secondary container or support;
an activation of the sample collection unit for carrying out:
a collection of the volume of the sample contained in said primary container, and
a release of the at least part of said volume in said at least one secondary container or support
the method further comprising an activation of a handling unit, for carrying out at least an opening and/or a closing of a stopper of said primary container configured for being removably coupled to a body of said primary container
and wherein the handling unit is configured and specifically destined to open and/or close stoppers and/or bodies of different size and/or shape.

19. The method according to claim 18, wherein the assembly formed by the support and by the handling unit adapts in a substantially automatic way at least at the opening and/or closing of:
at least one first stopper of a first primary container, and
at least one second stopper of a second primary container;
wherein the first and the second primary container differ in correspondence of said first and respectively second stopper, for type and/or shape and/or size or wherein the first and the second primary container differ in correspondence of said body for type and/or shape and/or size;
particularly wherein the activation, in a substantially automated way, of said handling unit comprises a substantially automatic adaptation of said handling unit at least at the opening and/or closing of:
at least one first stopper of a first primary container, and
at least one second stopper of a second primary container,
wherein the method comprises directly contacting the stopper of said primary container and/or said first stopper of said first primary container and said second stopper of said second primary container
wherein the activation, in a substantially automated way, of said handling unit, for at least the unscrewing of said stopper, occurs before the activation of the sample collection unit or occurs in substantial temporal simultaneity with the activation of the sample collection unit and/or with the movement of the sample collection unit;
the activation of said handling unit causing at least the opening of said stopper when said primary container is in said collecting position,
the activation of said handling unit causing a separation of said stopper from said body when in said collecting position and/or the activation of said handling unit causing the opening of said stopper by means of at least one between a movement of rotation and translation and preferably by means of a combined and simultaneous movement of rototranslation.

20. The method according to claim 18, wherein the sample collection unit releases at least part of the volume of said sample collected in secondary containers or supports of heterogeneous type,
and/or wherein the movement of the sample collection unit occurs between at least the collecting position and/or the first releasing position and a second releasing position, wherein:
in said first releasing position said sample collection unit releases at least a first part of the volume of said sample collected in a first secondary container or support;
in said second releasing position said sample collection unit releases at least one second part of the volume of said sample collected in at least one second secondary container or support;
preferably wherein the movement of the sample collection unit occurs automatically from the collecting position to the first releasing position and, subsequently, from the first releasing position (3b) to the second releasing position;
optionally wherein said sample collection unit comprises, or is, a pipetting unit and comprises a sample collection element in form of a hollow tip, and the method comprises retaining at least said volume of said sample by means of said hollow tip, said hollow tip being configured for being removably connected to a support for tips of said sample collection unit, and wherein the method comprises sucking or pushing at least part of said volume of said sample respectively inside or outside of said hollow tip by means of a pump of said sample collection unit, operatively connected to said hollow tip,
wherein the method comprises activating the sample collection unit for causing a movement of an actuator of said pump, and determining said volume of said sample collected from said primary container or at least partially released in said at least one secondary container or support and/or sucked or pushed respectively inside or outside of said hollow tip in function of the movement of said actuator,
or wherein the method comprises detecting a volume of sample present within said hollow tip by means of a volume sensor positioned on at least one between the sample collection unit and/or said hollow tip and comprises transmitting, starting from said volume sensor, a control signal having a value function of said volume of sample present within said hollow tip, a determination of said volume of said sample collected from said primary container or at least partially released in said at least one secondary container or support and/or sucked or pushed respectively inside or outside of said hollow tip occurring in function of the control signal provided by said volume sensor.

21-34. (canceled)
